(19) United States
(12) Patent Application Publication
(10) Pub. No.: US 2026/0336279 A1
(43) Pub. Date: Oct. 29, 2026

(54) INKJET RECORDING DEVICE

(71) Applicant: KEYENCE CORPORATION, Osaka-shi (JP)

(72) Inventor: Hideki Yamakawa, Osaka-shi (JP)

(73) Assignee: KEYENCE CORPORATION, Osaka-shi (JP)

(21) Appl. No.: 19/652,292

(22) Filed: Apr. 20, 2026

(30) Foreign Application Priority Data
Apr. 25, 2025 (JP) 2025-072993

(51) Int. Cl. B41J 2/03; B41J 2/085; B41J 2/09; B41J 2/165; B41J 2/175; B41J 2/185; B41J 29/393

(52) U.S. Cl. CPC B41J 2/03; B41J 2/085; B41J 2/09; B41J 2/16526; B41J 2/16552; B41J 2/175; B41J 2/185; B41J 29/393; B41J 2002/1853

(57) ABSTRACT

In a configuration in which a head module is attachable to and detachable from a head body of a print head, the head module is easily detached, and quick trouble recovery is not hindered. The print head includes a head body to which a cable is connected, the head body supplying ink to a print nozzle via the cable, and a separation head module configured to be detachable from the head body, the separation head module accommodating at least an electrode related to deflection of the ink. The inkjet recording device includes a cleaning unit for cleaning an electrode related to deflection of the ink stored in the separation head module.

### CROSS-REFERENCE TO RELATED APPLICATIONS

The present application claims foreign priority based on Japanese Patent Application No. 2025-072993, filed Apr. 25, 2025, the contents of which are incorporated herein by reference.

### BACKGROUND OF THE INVENTION

### 1. Technical field

The disclosure relates to an inkjet recording device.

### 2. Description of the Related Art

For example, JP2021-091181A discloses a so-called continuous inkjet recording device in which ink is circulated inside a device even when printing is not performed on a workpiece. The continuous inkjet recording device includes a print head and a controller, and each component such as a nozzle, a charging electrode, a deflection electrode, and a gutter is housed in the print head.

A connection cable connecting the print head and the controller includes a plurality of fluid conduits and electrical wirings, such as a supply tube for supplying ink, a collection tube for collecting ink, the charging electrode, and electrical wirings for applying a predetermined voltage to a deflection voltage.

Incidentally, a printing error may occur during operation of the inkjet recording device. As a cause of this printing error, for example, pump abnormality in the controller, clogging of an ink flow path, nozzle clogging in the print head, a failure of the charging electrode or the deflection electrode, and the like can be considered. Of these, when the charging electrode or the deflection electrode fails, the print head needs to be sent to a manufacturer or repair shop. Since the print head and the controller are integrated by the connection cable, both the print head and the controller need to be sent, and the absence of a spare body or the like leads to a prolonged downtime.

Here, for example, it is conceivable to configure a head module in which the charging electrode and the deflection electrode are modularized and to make the head module detachable from the print head. In a case where any of the charging electrode and the deflection electrode fails, when the head module is removed from the print head, only the module is sent to the manufacturer or the repair shop, and a spare head module is attached to a head body in a state where the head module is removed, a trouble can be quickly recovered, and furthermore, an increase in the downtime can be prevented.

However, in a case where a contact portion between the head module and the head body is fixed due to ink contamination or the like, it is difficult to remove the head module. As a result, rapid trouble recovery may be hindered.

### SUMMARY OF THE INVENTION

The disclosure has been made in view of such a point, and an object of the disclosure is to facilitate removal of a head module in a configuration in which the head module is detachable from a head body of a print head so as not to hinder quick trouble recovery.

In order to achieve the above object, one embodiment of the disclosure provides a continuous inkjet recording device that includes a print head that houses a print nozzle that ejects particulate ink, a charging electrode that charges the particulate ink ejected from the print nozzle, a deflection electrode that deflects a flying direction of the ink charged by the charging electrode, and a gutter that collects ink not deflected by the deflection electrode therein, and ejects the ink deflected by the deflection electrode to an outside, a controller that includes an ink supply unit that supplies the ink to the print head, a solvent supply unit that supplies a solvent to the print head, and a control unit that controls the ink supply or the solvent supply from the ink supply unit or the solvent supply unit to the print head, and a cable that fluidly and electrically connects the print head and the controller, and supplies the ink from the controller to the print head.

The print head includes a head body to which the cable is connected and which supplies the ink to the print nozzle via the cable, and a separation head module that is configured to be detachable from the head body, and houses at least an electrode related to the deflection of the ink. The inkjet recording device further includes a cleaning unit that cleans the electrode related to the deflection of the ink housed in the separation head module.

According to this configuration, since the separation head module housing the electrode related to the deflection of the ink is configured to be detachable from the head body, in a case where the electrode related to the deflection of the ink fails, the trouble can be quickly recovered by detaching the failed separation head module from the head body and then attaching another separation head module to the head body. At this time, since the electrode related to the deflection of the ink housed in the separation head module is cleaned by the cleaning unit, the ink deposits are less likely to occur, and the head module can be easily detached.

As described above, since the electrode related to the deflection of the ink housed in the separation head module can be cleaned by the cleaning unit, the separation head module can be easily removed from the head body and can be prevented from hindering quick trouble recovery.

### BRIEF DESCRIPTION OF THE DRAWINGS

FIG. 1 is a diagram illustrating an overall configuration of an inkjet recording device;

FIG. 2 is a block diagram illustrating a schematic configuration of the inkjet recording device;

FIG. 3 is a diagram illustrating a schematic configuration of a print head;

FIG. 4A is a diagram illustrating a cleaning operation by a shaft-like solvent;

FIG. 4B is a diagram illustrating a cleaning operation using a high-pressure air;

FIG. 4C is a diagram illustrating a cleaning operation by a cleaning nozzle;

FIG. 4D is a diagram illustrating an immersion cleaning operation;

FIG. 4E is a diagram illustrating a cleaning operation using a small amount of solvent by the cleaning nozzle;

FIG. 4F is a diagram illustrating a cleaning operation by the cleaning nozzle in a state where the print head is placed on a cleaning and placing unit;

FIG. 4G is a diagram illustrating a cleaning operation using the cleaning nozzle of the cleaning and placing unit;

FIG. 4H is a diagram illustrating a cleaning operation in which a shutter is in a closed state;

FIG. 5 is a diagram illustrating paths of ink and a solvent in the inkjet recording device;

FIG. 6 is a block diagram illustrating a schematic configuration of an air jetting module;

FIG. 7 is a flowchart illustrating processing in a case where an error is output even though a trigger is not input;

FIG. 8 is a flowchart illustrating processing in a case where an error is output after a trigger is input;

FIG. 9 is a flowchart of a recovery operation;

FIG. 10 is a flowchart illustrating details of the recovery operation;

FIG. 11 is a diagram for explaining the growth of ink deposits of a deflection electrode;

FIG. 12 is a flowchart illustrating preventive cleaning processing;

FIG. 13A is a time chart illustrating a cleaning timing according to a first example;

FIG. 13B is a time chart illustrating a cleaning timing according to a second example;

FIG. 14A is a diagram corresponding to FIG. 3 according to Modification 1;

FIG. 14B is a diagram corresponding to FIG. 3 according to Modification 2;

FIG. 14C is a diagram corresponding to FIG. 3 according to Modification 3; and

FIG. 14D is a diagram corresponding to FIG. 3 according to Modification 4.

### DETAILED DESCRIPTION

Hereinafter, embodiments of the invention will be described in detail with reference to the drawings. Note that, the following description of preferred embodiments is merely exemplary in nature and is not intended to limit the invention, the application thereof, or the use thereof. For example, a relative size and a positional relationship of each member illustrated in the drawings are for explaining one embodiment, and do not limit the invention.

In the present specification, an industrial inkjet printer will be described as an example of an inkjet recording device, but the technology disclosed herein can be applied to a general device configured to cause particulate ink (hereinafter, also referred to as ink particles) to fly and land on print objects such as a workpiece regardless of names of the inkjet recording device and the industrial inkjet printer.

Furthermore, in the present specification, printing by the inkjet recording device will be described, but the "printing" referred to herein includes, for example, all kinds of machining processing applying inkjet, such as printing of characters, marking of figures, and the like.

### Overall configuration

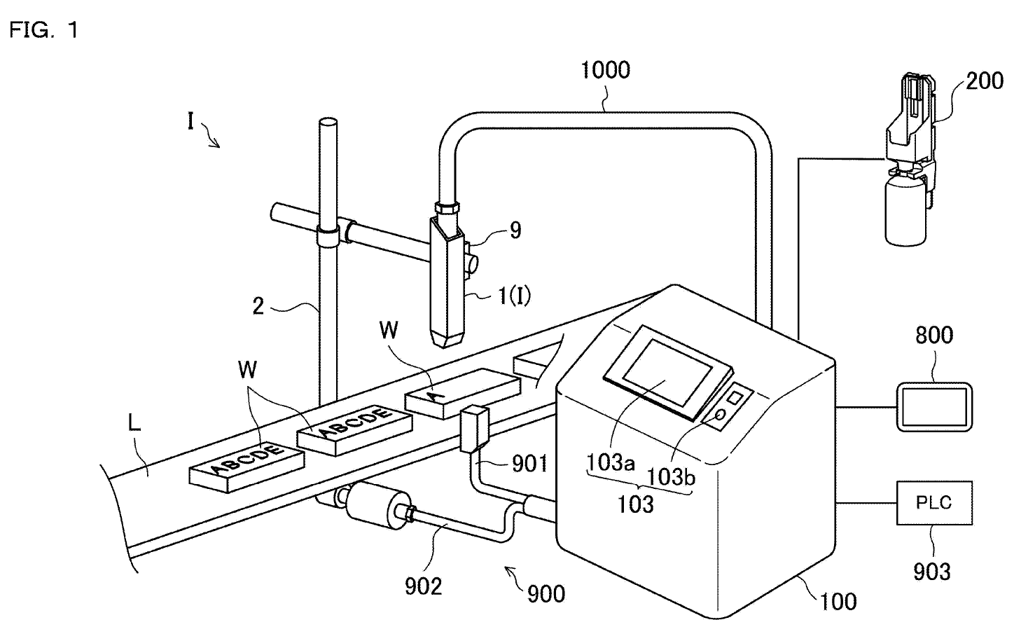

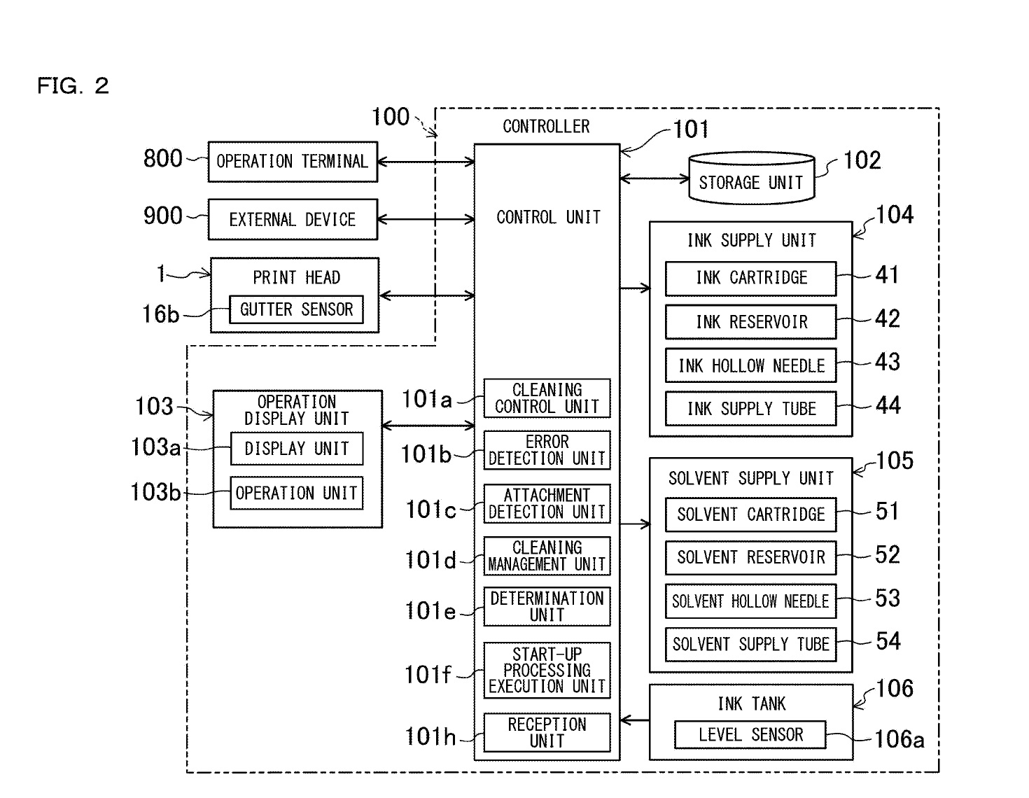

FIG. 1 is a diagram illustrating an overall configuration of an inkjet recording device I. Furthermore, FIG. 2 is a diagram illustrating a schematic configuration of the inkjet recording device I. The inkjet recording device I illustrated in FIG. 1 is installed in, for example, a conveyance line (production line) L in a factory or the like, and is configured to sequentially perform printing on each print object (also referred to as a workpiece) W flowing through the conveyance line L. The conveyance line L can include, for example, a belt conveyor or the like.

The inkjet recording device I includes a print head 1 that ejects ink particles from a print nozzle 12 and causes the ink particles to land on a print object W, a controller 100 that supplies a control signal, ink, and a solvent to the print head 1, and a connection cable 1000 that connects the print head 1 and the controller 100. The controller 100 supplies the control signal to the print head 1 to control a trajectory of the ink particles. As a result, a landing position of the ink particles on the print object W is adjusted, and desired printing is realized. The print head 1 is fixed at a predetermined position by a support member 2 or the like.

The inkjet recording device I is a continuous inkjet recording device (Continuous Inkjet Printer: CIJ). That is, in order to prevent clogging (in particular, clogging of the nozzle 12) and the like due to volatilization of the ink, even when the inkjet recording device I is not executing printing, the ink constantly circulates inside the inkjet recording device I as long as the inkjet recording device I is in an operating state. The continuous type is adopted, and thus, a quick-drying ink can be used without causing clogging by the ink. Furthermore, the inkjet recording device I according to the present embodiment can adjust a density (viscosity) of the ink by mixing the solvent and the ink.

Furthermore, the inkjet recording device I according to the present embodiment supplies a liquid that dissolves ink from the controller 100 to the print head 1 in cleaning processing to be described later. This liquid is used for cleaning in the print head 1. In the present embodiment, the solvent for adjusting the density (viscosity) of the ink is used for the liquid that dissolves the ink and is used for cleaning in the print head 1.

In a case where the solvent is used for the liquid, the solvent used for cleaning in the print head 1 can be collected as needed and reused to adjust the density (viscosity) of the ink or reused for further cleaning in the print head 1.

Note that it is not essential to use the solvent for adjusting the density (viscosity) of the ink for the liquid for the cleaning processing. Any liquid that can dissolve the ink, such as an organic solvent including ethanol, can be used for the cleaning processing.

The inkjet recording device I according to the present embodiment also includes a cleaning and placing unit 200 used when the print head 1 is cleaned. Details of the cleaning and placing unit 200 will be described later. Note that the cleaning and placing unit 200 may be provided as necessary, and may be omitted.

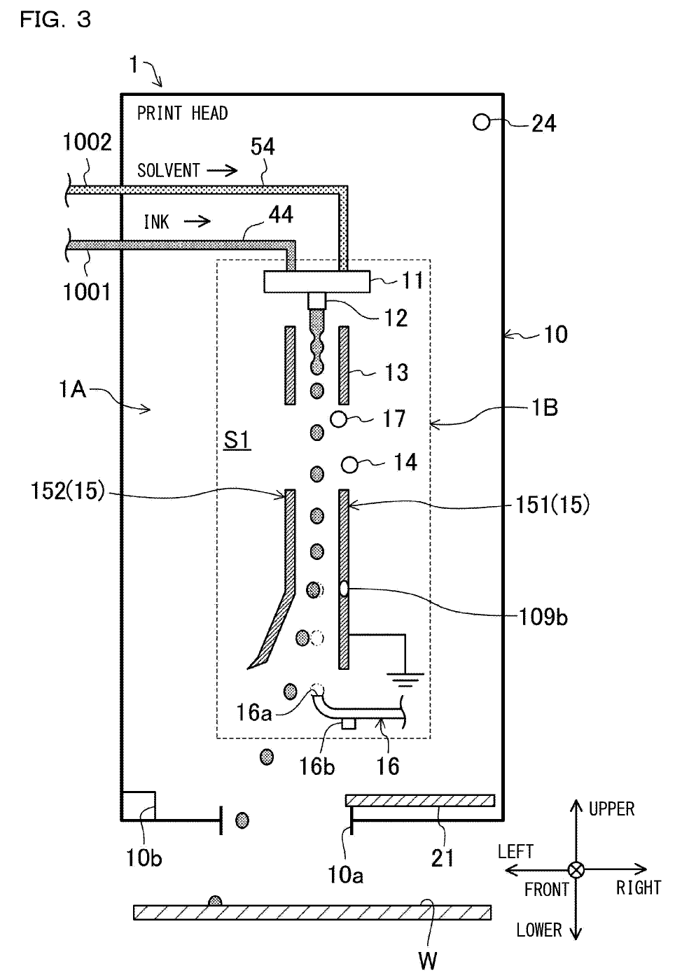

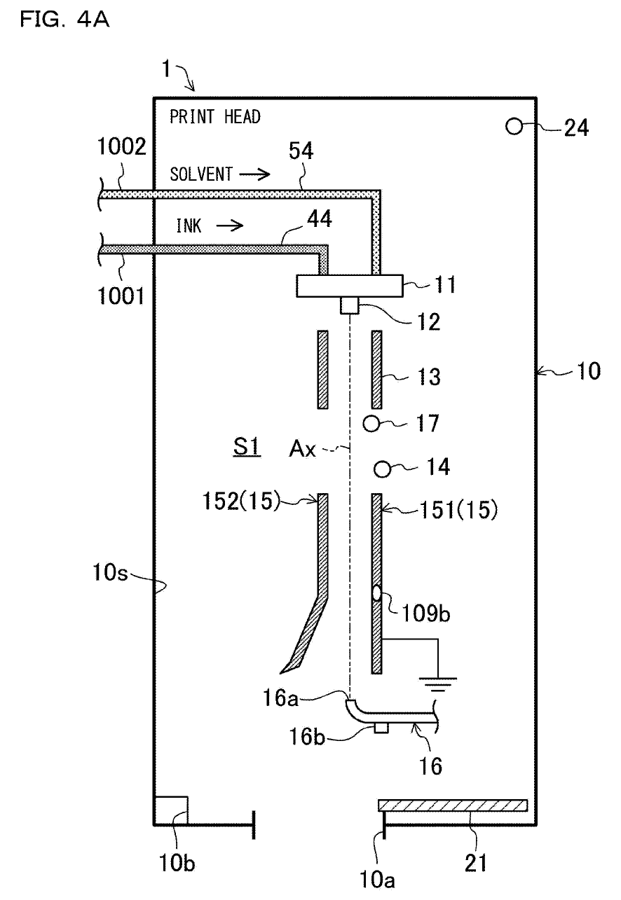

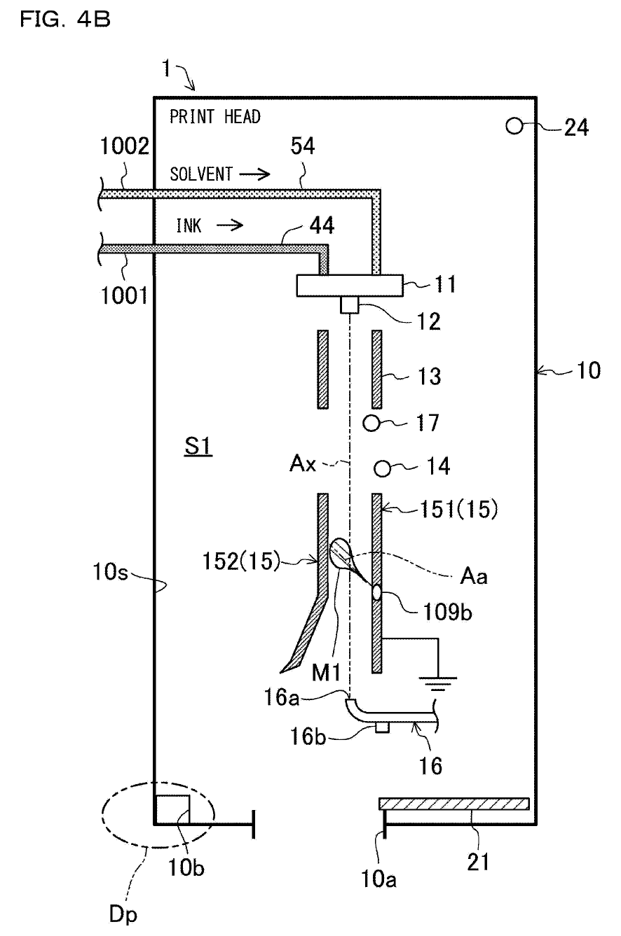

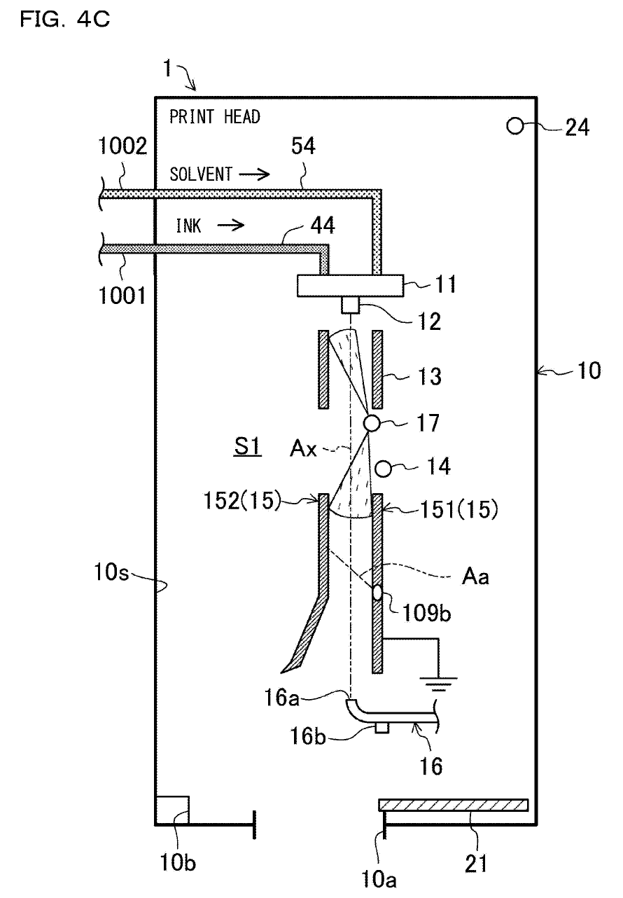

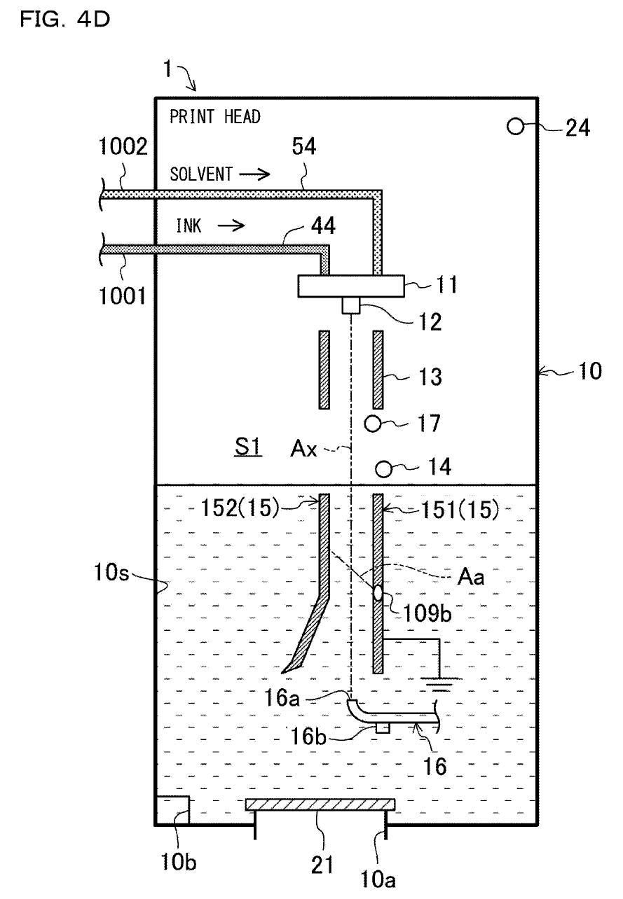

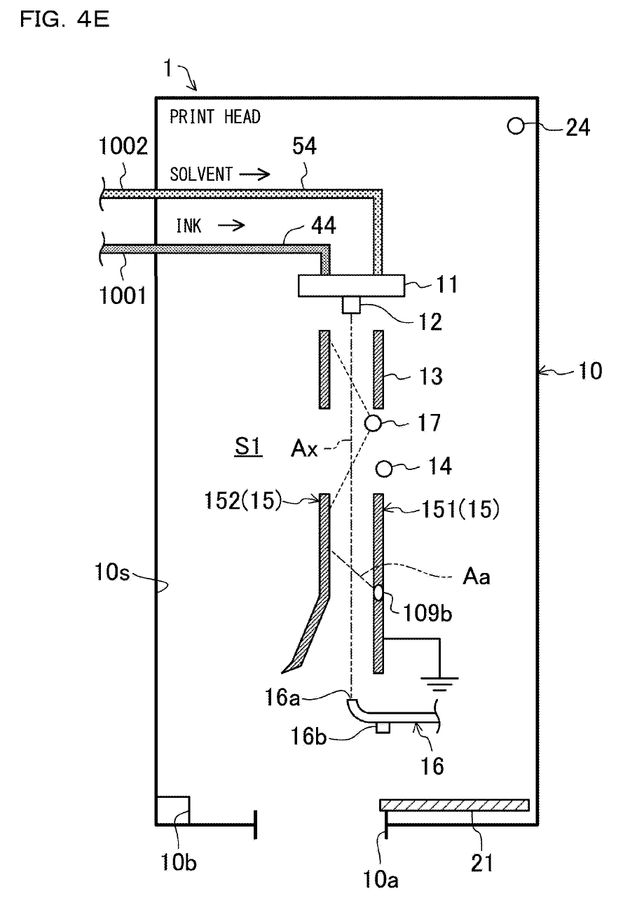

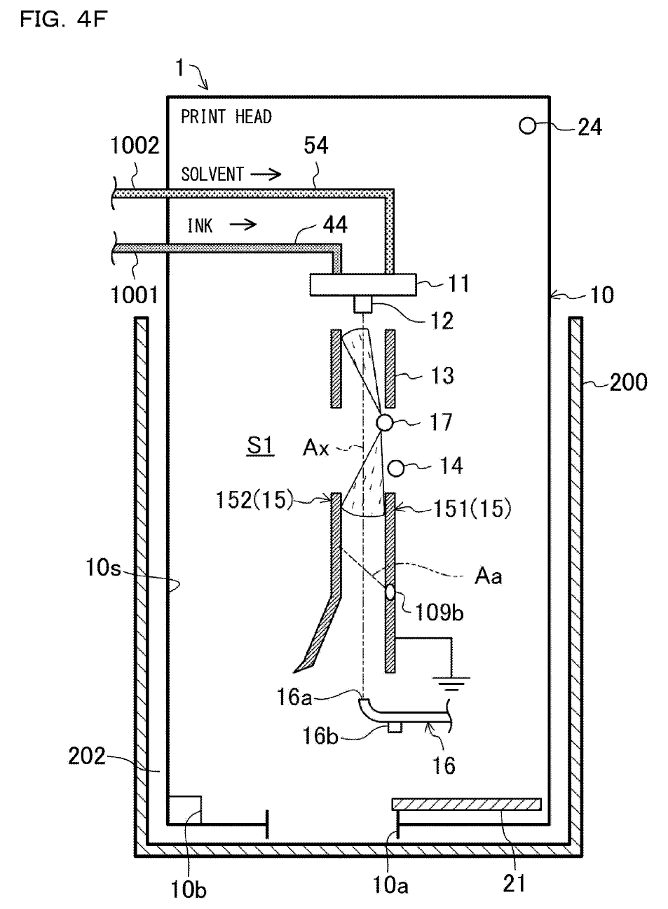

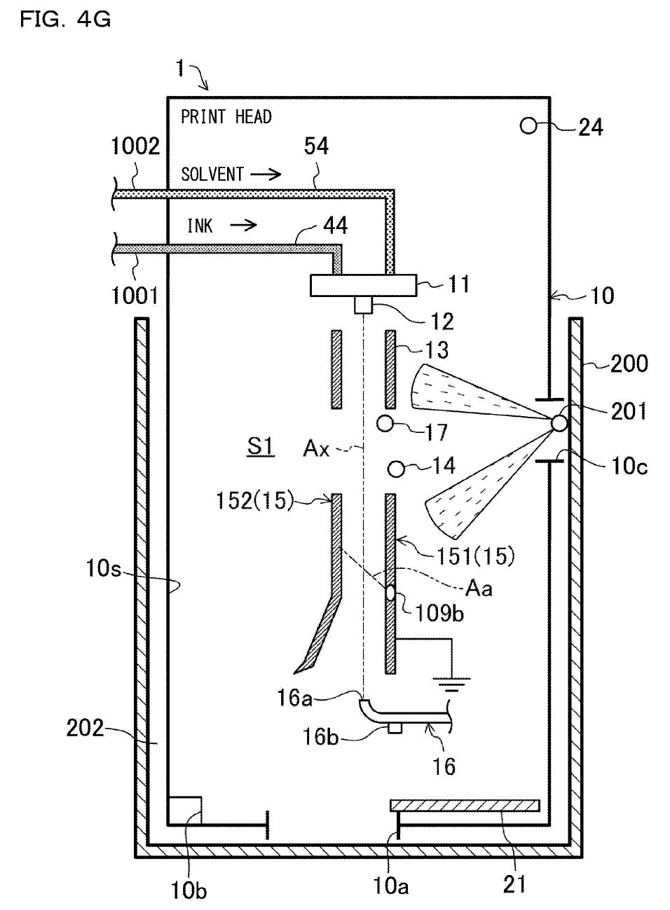

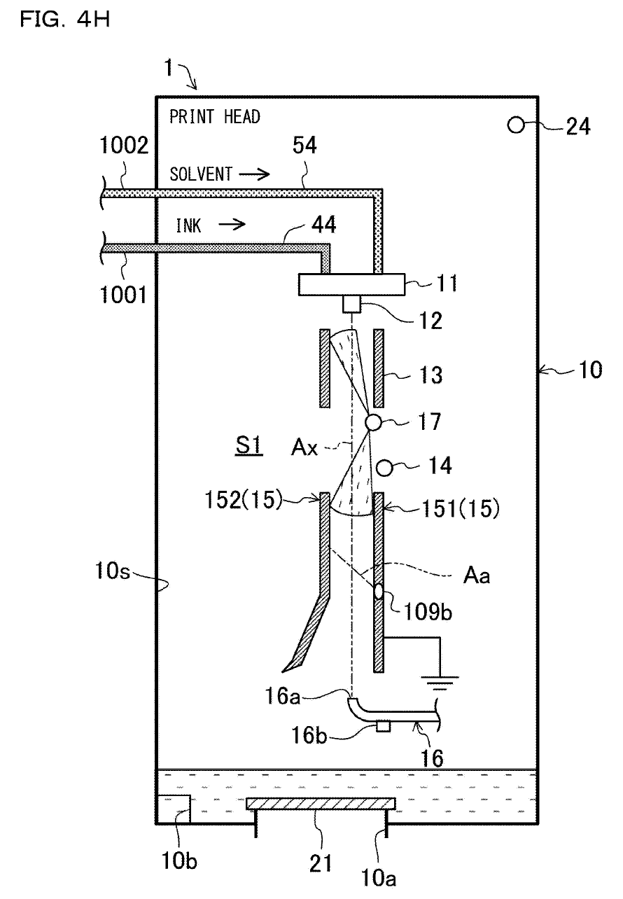

In order to realize the circulation of the ink, the print head 1 includes a gutter 16 that collects the ink or the solvent ejected from the print nozzle 12 in addition to the print nozzle 12 that ejects the ink or the solvent (see FIGS. 3, 4A-4H). The ink or solvent fed from the controller 100 to the print head 1 is ejected from the print nozzle 12 and collected by the gutter 16. FIGS. 4A -4H are diagrams for explaining a cleaning operation of the print head 1, and each cleaning operation will be described later.

The inkjet recording device I includes an operation terminal 800. The operation terminal 800 includes, for example, a central processing unit (CPU) and a storage device, and is connected to the controller 100. The operation terminal 800 defines print settings and functions as a terminal for indicating information related to printing to a user. The print settings set by the operation terminal 800 are output to the controller 100 and are stored in a storage unit 102.

The inkjet recording device I includes an external device 900. The external device 900 is connected to the controller 100 as necessary. In the example illustrated in FIGS. 1 and 2, a workpiece detection sensor 901, a conveyance speed sensor 902, and a programmable logic controller (PLC) 903 are provided as the external device 900.

The workpiece detection sensor 901 detects the presence or absence of the print object W on the conveyance line L, and outputs a signal (detection signal) indicating the detection result to the controller 100. The detection signal output from the workpiece detection sensor 901 functions as a trigger (printing trigger) for starting printing.

The conveyance speed sensor 902 includes, for example, a rotary encoder, and can detect a conveyance speed of the print object W. The conveyance speed sensor 902 outputs the signal (detection signal) indicating the detection result to the controller 100. The controller 100 controls a timing and the like of ejecting the ink particles from the print head 1 based on the detection signal input from the conveyance speed sensor 902.

As illustrated in FIG. 2, the PLC 903 is electrically connected to the controller 100. The PLC 903 is used to control the inkjet recording device I according to a predetermined sequence. Note that a command such as a remote cleaning instruction may be sent from the PLC 903 or the like to the controller 100 of the inkjet recording device I by communication. That is, the controller 100 may be configured to execute various types of cleaning based on a cleaning instruction command received from the PLC 903 or the like.

### Controller 100

The controller 100 is configured to supply ink to the print head 1 and send control signals for controlling components of the print head 1 to the print head 1. Here, the components of the print head 1 include the print nozzle 12, a charging electrode 13, and a deflection electrode 15, which will be described later. The controller 100 also supplies a solvent for diluting the ink to the print head 1 in addition to the ink for printing.

The controller 100 includes, as components related to electrical control, the storage unit 102 that stores the above-described print settings, a control unit 101 that controls the controller 100 and each unit of the print head 1, and an operation display unit 103 that receives an operation by the user and displays information to the user.

The controller 100 further includes, as components related to supply of ink and the like, an ink supply unit 104, a solvent supply unit 105, and an ink tank 106. These components are in direct or indirect fluid connection with the print head 1. At least in the present embodiment, the controller 100 houses the ink supply unit 104, the solvent supply unit 105, and the control unit 101 therein.

The ink supply unit 104 includes an ink reservoir 42 that detachably receives an ink cartridge 41 in which ink is housed. The ink supply unit 104 supplies ink to the print head 1. Meanwhile, the solvent supply unit 105 includes a solvent reservoir 52 that detachably receives a solvent cartridge 51 in which a solvent is housed. The solvent supply unit 105 supplies the solvent to the print head 1. In the cleaning processing to be described below, the solvent supply unit 105 supplies the liquid (solvent in the present embodiment) that dissolves the ink to the print head 1.

The ink tank 106 saves up, as printing ink, the ink from the ink cartridge 41 received in the ink reservoir 42 and the solvent from the solvent cartridge 51 received in the solvent reservoir 52. The "printing ink" referred to herein means a mixture of the solvent and the ink (for example, ink whose density is adjusted by the solvent).

The print head 1 performs printing using the printing ink from the ink tank 106. The print head 1 also cleans each unit in the print head 1 such as the print nozzle 12 by the solvent supplied from the solvent supply unit 105 while bypassing the ink tank 106.

The storage unit 102 is configured to store the print settings set via the operation display unit 103 or the operation terminal 800 to be described later, and output the stored print settings to the control unit 101 based on a control signal from an outside. The storage unit 102 may store information related to head cleaning. The information related to head cleaning includes information related to processing performed by a cleaning control unit 101a. The information related to processing performed by the cleaning control unit 101a includes a cleaning pattern of head cleaning and a cleaning time of head cleaning.

The control unit 101 is a processing unit that controls ink supply from the ink supply unit 104 to the print head 1 and controls solvent supply from the solvent supply unit 105 to the print head 1. Specifically, the control unit 101 controls at least the ink supply unit 104 and the solvent supply unit 105 in the controller 100 and the print nozzle 12, the charging electrode 13, and the deflection electrode 15 in the print head 1 based on the print settings stored in the storage unit 102. The control unit 101 controls each unit to perform printing on the print object W at a predetermined timing.

The control unit 101 includes, for example, a CPU, a memory, an input and output bus, and the like, and generates a control signal based on a signal indicating information input via the operation display unit 103 or the operation terminal 800 and a signal indicating the print setting read from the storage unit 102. The control unit 101 controls printing on the print object W by outputting the control signal generated in this manner to each unit.

For example, when printing is performed on the print object W, the control unit 101 reads a print content for the print object W stored in the storage unit 102 and generates a control signal based on the print content. Then, the control unit 101 sets a flying direction of the ink particles to realize a landing position corresponding to the print content by outputting the control signal to the charging electrode 13.

As illustrated in FIG. 1, the operation display unit 103 includes a display unit 103a that displays information to the user and an operation unit 103b that receives an operation by the user. The display unit 103a displays various types of information related to the inkjet recording device I. The display unit 103a includes, for example, a liquid crystal display panel, an organic EL display panel, or the like, and changes a display aspect in response to a control signal from the control unit 101. The display unit 103a can display a user interface for operating each unit of the inkjet recording device I, a user interface for setting the print settings, and a user interface related to head cleaning.

The operation unit 103b includes, for example, a touch operation panel, a button, a switch, and the like. When the user operates the operation unit 103b, information (operation information) corresponding to the operation input is input to the control unit 101, and the control unit 101 can detect which operation has been performed. For example, the operation unit 103b is operated, and thus, it is possible to switch power ON or OFF and the like of the inkjet recording device I, and to perform various settings, input information, and the like. The operation display unit 103 can also set the print settings similarly to the operation terminal 800 described above.

The ink supply unit 104 supplies, as the printing ink, the ink from the ink cartridge 41 to the print nozzle 12 of the print head 1. At this time, the ink from the ink supply unit 104 is supplied to the print head 1 via the ink tank 106.

Specifically, the ink supply unit 104 according to the present embodiment includes the ink cartridge 41 and the ink reservoir 42 described above, an ink hollow needle 43, and an ink supply tube 44. The ink hollow needle 43 fluidly connects the ink cartridge 41 and the ink supply tube 44. The ink supply tube 44 fluidly connects the ink cartridge 41 and the print head 1 via the ink hollow needle 43 and a connection cable 1000. The ink tank 106 is arranged in the middle of the ink supply tube 44 from the ink hollow needle 43 to the print head 1.

The ink cartridge 41 houses ink. The ink reservoir 42 detachably receives the ink cartridge 41. The ink cartridge 41 is replaced with respect to the ink reservoir 42, and thus, ink can be replenished to the ink tank 106.

The ink supply tube 44 constitutes a path for supplying the printing ink to the print head 1 together with the connection cable 1000 to be described later. Ink can be circulated between the print head 1 and the controller 100 by the path constituted by the ink supply tube 44.

A plurality of opening and closing valves including a first valve V1 and a plurality of pumps including a first pump P1 are provided in the ink supply tube 44. Among these components, since each opening and closing valve is constituted by an electromagnetic valve, each opening and closing valve is hereinafter also simply referred to as an electromagnetic valve. Each opening and closing valve can be opened and closed in response to a control signal output from the control unit 101 to control a flow of the ink. On the other hand, each pump receives a control signal output from the control unit 101 to pressure-feed the ink, and can control the flow of the ink similarly to the opening and closing valve.

The solvent supply unit 105 supplies the solvent from the solvent cartridge 51 to the ink tank 106 similarly to the ink, or supplies the solvent alone to the print nozzle 12. The former solvent forms the printing ink together with the ink by adjusting the density of the ink, and is supplied to the print head 1.

In a case where the print head 1 is caused to perform printing, the solvent from the solvent supply unit 105 is guided to the print nozzle 12 via the ink tank 106. On the other hand, in a case where the solvent is supplied alone (for example, in a case where the cleaning of the print head 1 to be described later is performed), the solvent from the solvent supply unit 105 is guided to the print nozzle 12 without passing through the ink tank 106.

The solvent cartridge 51 houses the solvent. The solvent reservoir 52 detachably receives the solvent cartridge 51. The solvent cartridge 51 is replaced with respect to the solvent reservoir 52, and thus, it is possible to replenish the solvent for density adjustment and the solvent for cleaning.

The solvent supply unit 105 includes the solvent cartridge 51 and the solvent reservoir 52 described above, a solvent hollow needle 53, and a solvent supply tube 54. The solvent hollow needle 53 fluidly connects the solvent cartridge 51 and the solvent supply tube 54. The solvent supply tube 54 fluidly connects the solvent cartridge 51 and the print head 1 to the solvent cartridge 51 and the ink tank 106 via the solvent hollow needle 53 and the connection cable 1000.

The solvent cartridge 51 houses the solvent. The solvent reservoir 52 detachably receives the solvent cartridge 51. The solvent cartridge 51 is replaced with respect to the solvent reservoir 52, and thus, it is possible to replenish the solvent for density adjustment and the solvent for cleaning.

The solvent supply tube 54 constitutes a path for supplying the solvent to the ink tank 106 or supplying the solvent to the print head 1 without interposing the ink tank 106, together with the connection cable 1000 to be described later. These paths allow the printing ink to be produced from the ink and solvent, and the print head 1 to be cleaned with the solvent.

A plurality of opening and closing valves including a twelfth valve V12 and a plurality of pumps including a second pump P2 are provided in the solvent supply tube 54. Among these components, since each opening and closing valve is constituted by an electromagnetic valve, each opening and closing valve is hereinafter also simply referred to as an electromagnetic valve. Each opening and closing valve can be opened and closed in response to a control signal output from the control unit 101 to control a flow of the solvent. On the other hand, each pump receives a control signal output from the control unit 101 to pressure-feed the solvent, and can control the flow of the solvent similarly to the electromagnetic valve.

The ink tank 106 is a member that saves up the ink from the ink cartridge 41 and the solvent from the solvent cartridge 51, and is a container that houses ink whose density (viscosity) is adjusted by the solvent, that is, a mixture of the ink and the solvent. The printing ink supplied from the ink tank 106 to the print nozzle 12 lands on a surface of the print object W at the time of printing, and is collected by the gutter 16 and sent back to the ink tank 106 at the time of non-printing. As a result, the circulation of the printing ink is realized. The solvent supplied to the print nozzle 12 for cleaning is also collected by the gutter 16, and then fed to the ink tank 106 through, for example, a conditioning tank 107 dedicated to the solvent, and can be reused for ink density adjustment.

A level sensor 106a (illustrated in FIG. 2) for detecting a liquid level (so-called liquid surface level) in the tank is provided in the ink tank 106. The level sensor 106ais electrically connected to the control unit 101, and inputs a detection signal thereof to the controller 100.

The connection cable 1000 fluidly and electrically connects the print head 1 and the controller 100. The connection cable 1000 has flexibility and is connected to an upper end of the print head 1 (see FIG. 1). One end of the connection cable 1000 is connected to the print head 1, and the other end is connected to the controller 100. The connection cable 1000 is formed by bundling a power supply wiring for transmitting and receiving a control signal between the print head 1 and the controller 100, an ink tube 1001 for transmitting and receiving ink therebetween, and a solvent tube 1002 for transmitting and receiving a solvent therebetween (see FIGS. 3, 4A-4G). The ink tube 1001 for transmitting and receiving ink between the print head 1 and the controller 100 is continuous with the ink supply tube 44. The solvent tube 1002 for transmitting and receiving a solvent between the print head 1 and the controller 100 is continuous with the solvent supply tube 54.

The print head 1 ejects ink (printing ink) whose density is adjusted based on the control signal supplied from the controller 100, the ink, and the solvent into particulate ink (hereinafter, also referred to as "ink particles"). The print head 1 can execute printing on the print object W by deflecting the flying direction of the ejected ink particles and causing the deflected ink particles to land on the surface of the print object W. The details of printing at this time are in accordance with the above-described print settings. The print head 1 can sequentially perform printing on each of the print objects W according to the print settings.

As illustrated in FIG. 3, the print head 1 includes a pressurizer 11, the print nozzle 12, the charging electrode 13, the deflection electrode 15, the gutter 16, a cleaning nozzle 17, and a shutter 21. The pressurizer 11 pressurizes the printing ink to form the particulate ink. The print nozzle 12 ejects the particulate ink. The charging electrode 13 charges the particulate ink ejected from the print nozzle 12. The deflection electrode 15 deflects the flying direction of the printing ink charged by the charging electrode 13. The gutter 16 collects the printing ink not deflected by the deflection electrode 15 or the solvent ejected from the print nozzle 12. Furthermore, the print head 1 includes a charging detection sensor 14 that monitors a charging state of the printing ink, and a gutter sensor 16b that detects whether or not the ink is in the gutter 16.

The print head 1 includes a housing 10 that houses the pressurizer 11, the print nozzle 12, the charging electrode 13, the charging detection sensor 14, the deflection electrode 15, the gutter 16, the gutter sensor 16b, and the cleaning nozzle 17 therein and defines a flying space S1 of the ink particles. The print head 1 ejects the ink particles deflected by the deflection electrode 15 to an outside of the housing 10 via the flying space S1.

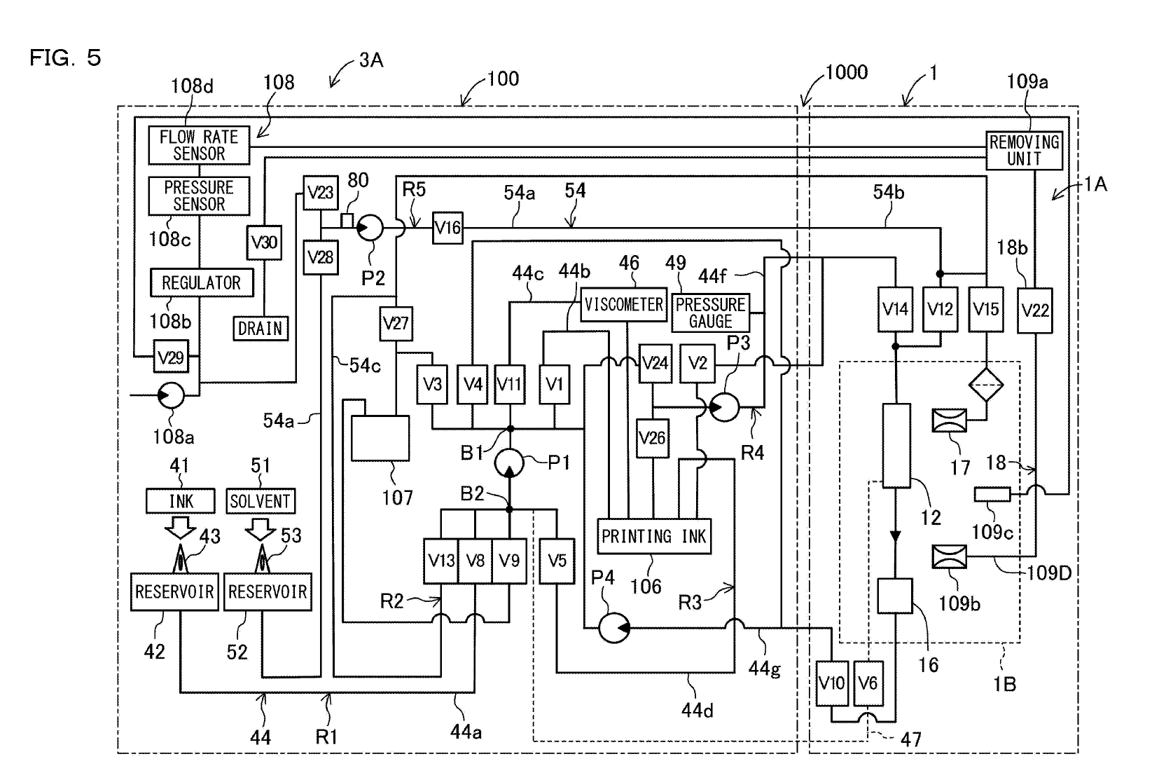

As illustrated in FIG. 5, the print head 1 includes a head body 1A to which the connection cable 1000 is connected and which supplies the ink to the print nozzle 12 via the connection cable 1000, and a separation head module (hereinafter, referred to as a head module) 1B which is configured to be detachable from the head body 1A and houses at least electrodes related to the deflection of the ink. The electrodes related to the deflection of the ink are the charging electrode 13 and the deflection electrode 15, and the head module 1B may house both the charging electrode 13 and the deflection electrode 15, or may house only one of the charging electrode and the deflection electrode. As illustrated in FIG. 3, the head module 1B includes the pressurizer 11, the print nozzle 12, the charging electrode 13, the deflection electrode 15, the gutter 16, and the cleaning nozzle 17. The pressurizer 11, the print nozzle 12, the charging electrode 13, the deflection electrode 15, and the gutter 16 are attached to and integrated with a base portion of the head module 1B. The base portion of the head module 1B is attached to the head body 1A, and thus, a printable state is obtained.

The head module 1B can be replaced with another head module. For example, in a case where the head module 1B in use fails, a normally operating head module is prepared, the head module 1B is removed from the head body 1A, and then the normally operating head module is attached to the head body 1A. Note that, as in each modification to be described later, the head module 1B may not include all of the pressurizer 11, the print nozzle 12, the charging electrode 13, the deflection electrode 15, and the gutter 16, and may include at least one of these members.

As illustrated in FIG. 2, the controller 100 includes an attachment detection unit 101c that detects whether or not the head module 1B is attached to the head body 1A. Examples of the attachment detection unit 101c include, but are not limited to, a proximity sensor that outputs an ON signal in a case where the head module 1B is attached to the head body 1A, a sensor using a magnetic force, a sensor that forms an electrical contact, and the like.

As illustrated in FIG. 3, the housing 10 extends in an upper-lower direction. In the following description, a longitudinal direction of the housing 10 is simply referred to as an "upper-lower direction", while two directions orthogonal to the upper-lower direction are referred to as a "front-rear direction" and a "left-right direction", respectively. In other drawings, directions corresponding to these directions are referred to as an "upper-lower direction", a "front-rear direction", and a "left-right direction", respectively. "Upper" refers to an upper side of FIG. 3, and "lower" refers to a lower side. Note that the print head 1 does not necessarily have an upper-lower direction along a vertical direction (gravity direction). The print head 1 may also be in a posture with an upper-lower direction along a horizontal direction.

The print head 1 has an ink ejection port 10a for ejecting the ink deflected by the deflection electrode 15 to the outside. The ink ejection port 10a opens on a lower surface of the housing 10. Hereinafter, the ink ejection port 10a is also simply referred to as an ejection port 10a. The ink particles are ejected from the ejection port 10a toward the lower side of the housing 10. As described above, the print head 1 has the ejection port 10a as an opening for ejecting the ink to the outside when printing is performed on the print object W.

As illustrated in FIG. 1, the print head 1 at the time of printing is supported by, for example, the support member 2. The print head is installed in a production line in a state of being supported by the support member 2. The print head 1 installed in the production line is arranged such that the ejection port 10a faces a print surface of the print object W from above. This location is an example of an installation location of the print head 1 when printing is performed by the inkjet recording device I.

The print head 1 includes an attachment portion 9 detachably attached to the support member 2 installed in the production line. The attachment portion 9 is provided on a back surface (rear surface) of the housing 10. The print head 1 is supported by the support member 2 via the attachment portion 9.

As illustrated in FIG. 3, the pressurizer 11 is arranged near an upper end of the housing 10 in the flying space S1. The printing ink is configured to be supplied to the pressurizer 11 from the ink tank 106 of the controller 100 via the connection cable 1000. The ink pressurized by the pressurizer 11 is supplied to the print nozzle 12.

The print nozzle 12 is connected to a lower end of the pressurizer 11, and is arranged in a posture in which an opening end (printing ink) thereof faces downward. The print nozzle 12 includes a piezoelectric element (for example, a piezoelectric device) that applies vertical vibration to the ink, and applies the vertical vibration to the ink pressurized by the pressurizer 11 and then ejects the ink from the ejection port (opening end). Due to this vibration, the ink liquid ejected from the print nozzle 12 is formed into particles after a predetermined time from an ejection timing.

The printing ink ejected from the print nozzle 12 without being subjected to vibration (without being vibrated) flows in a so-called “ink shaft” having a shaft shape. On the other hand, the printing ink ejected from the print nozzle 12 after being subjected to vibration (being vibrated) has a shaft shape immediately after being ejected from the print nozzle 12, but becomes a particle shape as being separated from the print nozzle 12. The granulated printing ink drops as so-called “ink particles”. The printing ink passes through the charging electrode 13 regardless of whether the printing ink is an ink shaft or ink particles. Note that, the solvent is ejected alone from the print nozzle 12, and thus, the solvent can flow in a shaft shape. Hereinafter, such a shaft-shaped solvent is also referred to as a “solvent shaft”. Central axes of the ink shaft and the solvent shaft are as indicated by a two-dot chain line Ax in FIG. 4A. The central axes Ax of the ink shaft and the solvent shaft extend so as to connect the print nozzle 12 and the gutter 16. The solvent supplied to clean the inside of the print head 1 passes through the pressurizer 11 and the print nozzle 12 in order, and spouts from a tip portion of the print nozzle 12. The solvent spouting in this manner flows in a shaft shape along a flight axis Ax and passes through the charging electrode 13.

For example, a suction path 47 illustrated in FIG. 5 is connected to the print nozzle 12, as a return path for releasing a pressure inside the print head 1 when the inkjet recording device I is stopped. The solvent can also be sucked from the print nozzle 12 through the suction path 47.

The charging electrode 13 includes a pair of metal plates having electrical conductivity, and is arranged below the print nozzle 12. Here, the pair of metal plates constituting the charging electrode 13 is fixed to the housing 10 in a posture in which longitudinal directions thereof are aligned with the upper-lower direction and in a posture in which the metal plates face each other in a horizontal direction. An interval between the pair of metal plates is set to be larger than a particle diameter of the ink ejected from the print nozzle 12, and the printing ink ejected from the print nozzle 12 passes between the pair of metal plates.

A potential (positive potential) is applied to the charging electrode 13 at least when a printing operation is executed. As a result, a potential difference is generated between the pressurizer 11 and the charging electrode 13, and the ink particles passing through the charging electrode 13 can be charged. In order to charge each ink particle, the charging electrode 13 according to the present embodiment is arranged near a breakpoint where the printing ink ejected from the print nozzle 12 is turned into particles. Note that the solvent ejected from the print nozzle 12 passes through a side of the charging detection sensor 14 and reaches the deflection electrode 15 without being charged.

The charging detection sensor 14 is arranged below the charging electrode 13. The charging detection sensor 14 is connected to a circuit board provided inside the housing 10. The charging detection sensor 14 can detect a charging state of the ink particle (in particular, the charge amount of each ink particle) passing through the side. A detection result by the charging detection sensor 14 is output, as a detection signal, to the control unit 101. The control unit 101 can determine whether or not each ink particle is appropriately charged based on this detection signal.

The deflection electrode 15 includes a pair of metal plates (so-called "counter electrodes") having electrical conductivity, and is arranged below the charging electrode 13 and the charging detection sensor 14. Here, the pair of metal plates is fixed to the housing 10 in a posture in which longitudinal directions thereof are substantially aligned with the upper-lower direction and in a posture in which the pair of metal plates face each other in the horizontal direction. The ink particles having passed between the pair of metal plates constituting the charging electrode 13 pass between the pair of metal plates constituting the deflection electrode 15.

A voltage (hereinafter, also referred to as "deflection voltage") that can be controlled by the controller 100 is applied to the deflection electrode 15. As a result, a potential difference corresponding to the deflection voltage is generated between the pair of metal plates constituting the deflection electrode 15. Due to this potential difference, the flying direction of the ink particles can be deflected in accordance with the charge amount of the ink particles. The flying direction of the ink particles can be deflected along an arrangement direction of the pair of metal plates constituting the deflection electrode 15.

The flying direction of the ink particles can be controlled via the deflection voltage applied to each of the charging electrode 13 and the deflection electrode 15. The ink particles whose flying direction is controlled in this manner include particles deflected by the deflection electrode 15 and particles not deflected by the deflection electrode 15 (particles not deflected). Among these particles, the ink particles deflected by the deflection electrode 15 are involved in the printing of the print object W. The ink particles deflected by the deflection electrode 15 are ejected from the ejection port 10a provided on the lower surface of the housing 10, and land on the print object W.

On the other hand, the ink particles that are not deflected by the deflection electrode 15 are not involved in the printing of the print object W. Such ink particles or the shaft-shaped printing ink that is not formed into the particles reach the inside of the gutter 16 as illustrated by a chain line in FIG. 3. Similarly, the solvent used for cleaning the print nozzle 12 and the like in the print head 1 and having passed through the deflection electrode 15 also reaches the inside of the gutter 16.

The deflection electrode 15 includes a first electrode plate 151 and a second electrode plate 152 facing the first electrode plate 151. The first electrode plate 151 is grounded. A high voltage is applied to the second electrode plate 152.

The gutter 16 is formed by using a curved tube having an opening 16a facing upward, and is arranged below the deflection electrode 15. The gutter 16 according to the present embodiment can collect the printing ink that is not involved in the printing of the print object W and the solvent (specifically, the solvent ejected from the print nozzle 12) that has passed through the print nozzle 12.

The opening end of the print nozzle 12 is positioned directly above the opening 16a of the gutter 16. With this arrangement, a fluid flowing from the opening end of the print nozzle 12 along the vertical direction and the flying fluid can be received from the opening 16a of the gutter 16.

A charge type or thermistor type gutter sensor 16b is provided in the gutter 16 (see FIG. 2). The gutter sensor 16b can detect whether or not the printing ink is in the gutter 16, can determine that the adjustment of the ink shaft is completed when the printing ink is in the gutter 16, and can determine that the adjustment of the ink shaft is not completed when the printing ink is not in the gutter 16. The gutter sensor 16b is connected to the control unit 101 of the controller 100, and is configured to output a signal to the control unit 101.

The printing ink or solvent collected by the gutter 16 is sent back to the controller 100 through the connection cable 1000, the ink supply tube 44, the solvent supply tube 54, and the like, and stored in the ink tank 106. The ink or solvent collected in this manner is sent back to the controller 100 for reuse. Such steps are repeated, and thus, the ink can be circulated.

The cleaning nozzle 17 is provided in the print head 1. The cleaning nozzle 17 functions as a so-called solvent jetting unit and a first solvent ejection nozzle. The cleaning nozzle 17 is a nozzle for ejecting or jetting the solvent to the print nozzle 12, the charging electrode 13, the deflection electrode 15, and the like in the print head 1 to clean these components, and can cause the solvent capable of dissolving ink to spout. The solvent jetted from the cleaning nozzle 17 is supplied from the solvent supply unit 105, for example, the solvent cartridge 51.

The shutter 21 opens or closes the ejection port 10a. The shutter 21 is electrically connected to the control unit 101 and opens or closes in response to a control signal from the control unit 101. The ejection port 10a is blocked with the shutter 21, and thus, for example, solvent leakage from the ejection port 10a can be suppressed in the head cleaning.

A solvent collection port 10b is provided in the housing 10. The solvent collection port 10b is an opening for collecting the solvent in the housing 10 in a case where, for example, the print nozzle 12, the charging electrode 13, the deflection electrode 15, and the like in the print head 1 are cleaned by supplying the solvent into the housing 10 in a state where the ejection port 10a is closed by the shutter 21. The solvent collection port 10b is connected to, for example, the suction path 47 and the like illustrated in FIG. 5. The solvent collection port 10b is arranged in the vicinity of a lower portion of the housing 10.

The ink supply tube 44 constitutes, for example, a path (first path R1) for feeding ink (ink before density adjustment) from the ink cartridge 41 to the ink tank 106. As illustrated in FIG. 5, the first path R1 includes a first ink tube 44a as an ink circulating tube, a second ink tube 44b, and a third ink tube 44c. The first ink tube 44a, the second ink tube 44b, and the third ink tube 44c are all arranged in the controller 100 in the present embodiment.

The first ink tube 44a has one end connected to the ink hollow needle 43 and the other end (see a branch portion B1 in FIG. 5) branching into the second ink tube 44b and the third ink tube 44c. The first ink tube 44a as the ink circulation tube connects the ink hollow needle 43 and the ink tank 106 via the second ink tube 44b and the third ink tube 44c, and circulates the ink from the ink hollow needle 43 to the ink tank 106. Note that, in the present embodiment, the ink is introduced into the ink tank 106 via the third ink tube 44c, but may be introduced via, for example, the second ink tube 44b. In this case, the ink is introduced into the ink tank 106 without passing through a viscometer 46.

The first pump P1 is arranged in the middle of the first ink tube 44a. The first pump P1 is a suction pump for sucking so as to generate a flow from the ink hollow needle 43 toward the first ink tube 44a.

An eighth valve V8 is arranged in the first ink tube 44a between the reservoir 42 and the first pump P1. The eighth valve V8 is an opening and closing valve that opens or closes a flow path of the first ink tube 44a.

The second ink tube 44b connects a branch portion B1 of the first ink tube 44a and the ink tank 106. The first valve V1 is arranged in the middle of the second ink tube 44b. The first valve V1 is an opening and closing valve that opens or closes a flow path of the second ink tube 44b.

The third ink tube 44c connects the branch portion B1 of the first ink tube 44a and the ink tank 106. An eleventh valve V11 is arranged in the middle of the third ink tube 44c. The eleventh valve V11 is an opening and closing valve that opens or closes a flow path of the third ink tube 44c.

The viscometer 46 is arranged in the third ink tube 44c between the eleventh valve V11 and the ink tank 106. The viscometer 46 detects a flow rate of the ink or the printing ink flowing through the third ink tube 44c, and measures the viscosity based on the flow rate. The viscometer 46 inputs a detection signal corresponding to the measurement result to the control unit 101.

The ink from the ink cartridge 41 sequentially passes through the ink hollow needle 43, the ink reservoir 42, the first ink tube 44a, the second ink tube 44b, and the third ink tube 44c based on an operation status of the first pump P1 and opening and closing statuses of the first valve V1, the eighth valve V8, and the eleventh valve V11, and is supplied to the ink tank 106.

The solvent supply tube 54 constitutes a second path R2 for feeding the solvent from the solvent cartridge 51 to the ink tank 106 together with a part of the ink supply tube 44.

As illustrated in FIG. 5, the second path R2 includes a first solvent tube 54a, a second solvent tube 54b, and a third solvent tube 54c of the solvent supply tube 54.

The first solvent tube 54a has one end connected to the solvent hollow needle 53 and the other end connected to the pressurizer 11 of the print head 1. A twenty-eighth valve V28, the second pump P2, a sixteenth valve V16, and the twelfth valve V12 are arranged in this order from an upstream side to a downstream side in the middle of the first solvent tube 54a in the solvent supply tube 54. The second pump P2 is a suction pump for sucking so as to generate a flow from the solvent hollow needle 53 toward the solvent supply tube 54.

The twenty-eighth valve V28, the sixteenth valve V16, and the twelfth valve V12 are opening and closing valves that open or close a flow path of the first solvent tube 54a. A portion between the sixteenth valve V16 and the twelfth valve V12 of the first solvent tube 54a is connected to the second solvent tube 54b.

The second solvent tube 54b connects the controller 100 and the print head 1 together with the solvent tube 1002. One end of the second solvent tube 54b is connected to the cleaning nozzle 17. For example, the twenty-eighth valve V28 and the sixteenth valve V16 are opened and the twelfth valve V12 is closed. Thus, the solvent can be supplied to the cleaning nozzle 17 via the first solvent tube 54a and the second solvent tube 54b.

The other end of the second solvent tube 54b is connected to a connecting portion B2 of the first ink tube 44a. A fifteenth valve V15, a twenty-seventh valve V27, the conditioning tank 107, and a ninth valve V9 are arranged in the middle of the second solvent tube 54b. The fifteenth valve V15, the twenty-seventh valve V27, and the ninth valve V9 are opening and closing valves that open or close a flow path of the second solvent tube 54b, and among these valves, the fifteenth valve V15 is a valve that controls the supply of the solvent to the cleaning nozzle 17.

The third solvent tube 54c has one end connected to the connecting portion B2 of the first ink tube 44a and the other end connected to a portion of the second solvent tube 54b between the fifteenth valve V15 and the twenty-seventh valve V27. A thirteenth valve V13 is arranged in the middle of the third solvent tube 54c. The thirteenth valve V13 is an opening and closing valve that opens or closes a flow path of the third solvent tube 54c.

The ink supply tube 44 also constitutes a path (third path R3) for circulating and stirring the reserved object (printing ink) in the ink tank 106 in the controller 100. The third path R3 includes a fourth ink tube 44d, the second ink tube 44b, and the third ink tube 44c of the ink supply tube 44.

The fourth ink tube 44d has one end connected to the ink tank 106 and the other end connected to the connecting portion B2 of the first ink tube 44a. A fifth valve V5 is arranged in the middle of the fourth ink tube 44d. The fifth valve V5 is an opening and closing valve that opens or closes a flow path of the fourth ink tube 44d.

The printing ink in the ink tank 106 is sucked out by the fourth ink tube 44d based on the operation status of the first pump P1 and opening and closing statuses of the first valve V1, the fifth valve V5, the ninth valve V9, and the eleventh valve V11, and then sequentially passes through a part of the first ink tube 44a (portion from the connection portion B2 to the branch portion B1 in FIG. 5), the second ink tube 44b, and the third ink tube 44c, and is sent back to the ink tank 106. As a result, the printing ink circulates in the controller 100.

The ink supply tube 44 further forms a fourth path R4 for feeding the printing ink from the ink tank 106 to the print nozzle 12 and feeding the printing ink back from the gutter 16 to the ink tank 106. The fourth path R4 includes the ink supply tube 44 and the ink tube 1001 of the connection cable 1000.

The fourth path R4 includes the ink tube 1001, and a sixth ink tube 44f and a seventh ink tube 44g of the ink supply tube 44. The sixth ink tube 44f and the seventh ink tube 44g connect the controller 100 and the print head 1 together with the ink tube 1001.

The sixth ink tube 44f has one end connected to the ink tank 106 and the other end connected to the print nozzle 12 via the ink tube 1001. A third pump P3 and a twenty-sixth valve V26 are arranged in the middle of the sixth ink tube 44f. The third pump P3 is a suction pump for sucking so as to generate a flow from the ink tank 106 toward the sixth ink tube 44f. The twenty-sixth valve V26 is an opening and closing valve that opens or closes a flow path of the sixth ink tube 44f.

A fourteenth valve V14 is arranged in the sixth ink tube 44f between the third pump P3 and the print nozzle 12. The fourteenth valve V14 is an opening and closing valve that opens or closes the flow path of the sixth ink tube 44f.

The seventh ink tube 44g has one end connected to the gutter 16 via the ink tube 1001 and the other end connected to the ink tank 106 via the sixth ink tube 44f. A fourth pump P4 and a twenty-fourth valve V24 are arranged in the middle of the seventh ink tube 44g. The fourth pump P4 is a suction pump for sucking so as to generate a flow from the gutter 16 toward the seventh ink tube 44g. The twenty-fourth valve V24 is an opening and closing valve that opens or closes a flow path of the seventh ink tube 44g. The other end of the seventh ink tube 44g is connected to a portion of the sixth ink tube 44f between the twenty-sixth valve V26 and the third pump P3.

The printing ink in the ink tank 106 is sucked out by the sixth ink tube 44f in accordance with an operation status of the third pump P3 and an opening and closing status of the twenty-sixth valve V26, and ejected from the print nozzle 12. The printing ink ejected from the print nozzle 12 lands on the surface of the print object W at the time of printing, and is collected by the gutter 16 at the time of non-printing. The latter printing ink is sucked out by the seventh ink tube 44g in accordance with an operation status of the fourth pump P4 and an opening and closing status of the twenty-fourth valve V24, and sent back to the ink tank 106. As a result, the printing ink circulates between the controller 100 and the print head 1.

The solvent supply tube 54 constitutes a fifth path R5 for feeding a cleaning solvent from the solvent cartridge 51 to the print nozzle 12 together with a part of the ink supply tube 44. The fifth path R5 includes the ink supply tube 44 and the solvent tube 1002 of the connection cable 1000.

As illustrated in FIG. 5, the fifth path R5 includes the solvent tube 1002 and the first solvent tube 54a in the solvent supply tube 54.

The solvent from the solvent cartridge 51 passes through the solvent hollow needle 53 and the solvent reservoir 52 in accordance with an operation status of the second pump P2 and opening and closing statuses of the twenty-eighth valve V28, the sixteenth valve V16, and the twelfth valve V12, and is supplied to a middle portion of the sixth ink tube 44f (a portion between the fourteenth valve V14 and the print nozzle 12). The solvent supplied to this portion is ejected from the print nozzle 12. This solvent cleans the print head 1.

Since the cleaning nozzle 17 is connected to the second solvent tube 54b, a solvent as a cleaning liquid can be ejected or jetted from the cleaning nozzle 17. In the middle from the cleaning nozzle 17 to the second solvent tube 54b, the fifteenth valve V15 for controlling the supply of the solvent to the cleaning nozzle 17 is provided.

The controller 100 includes the suction path 47 connected to the print nozzle 12, as a path related to the suction of the ink. A sixth valve V6 is provided in the suction path 47. For example, at the time of non-printing, the first pump P1 is operated in a state where the sixth valve V6 is opened, and thus, the ink can be sucked via the suction path 47 and the sucked ink can be sent back to the controller 100.

### Air jetting module

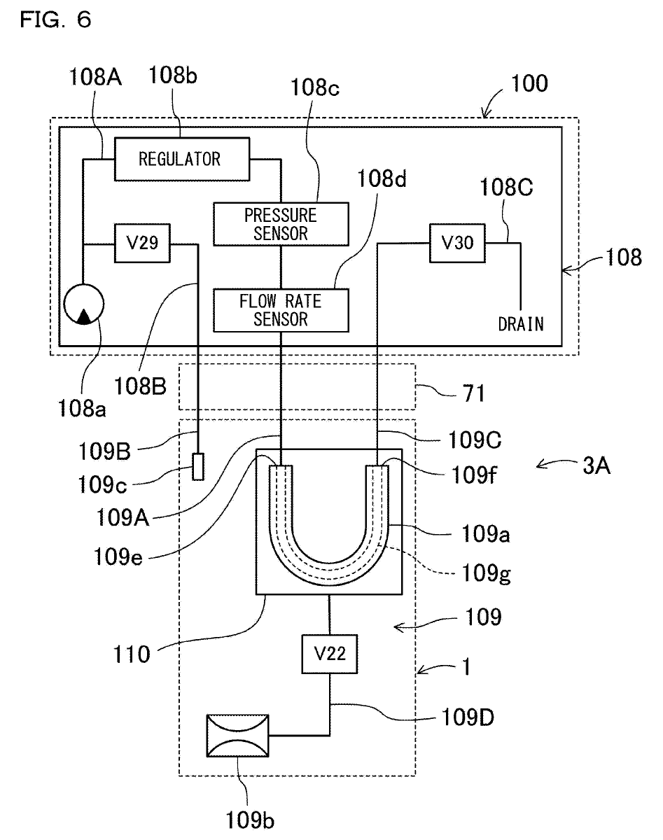

The inkjet recording device I according to the present embodiment includes an air jetting module 3A that supplies a high-pressure air into the print head 1, as an element related to the cleaning processing in the print head 1. As illustrated in FIG. 6, the air jetting module 3A includes a controller-side module 108 provided in the controller 100 and a head-side module 109 provided in the print head 1.

The controller-side module 108 includes an air pump 108a, a regulator 108b, a pressure sensor 108c, a flow rate sensor 108d, a twenty-ninth valve V29, and a thirtieth valve V30. The controller-side module 108 further includes, as tube elements, a first air feeding tube 108A, a second air feeding tube 108B, and a drain tube 108C. The twenty-ninth valve V29 and the thirtieth valve V30 are opening and closing valves (electromagnetic valves) controlled by the controller 100.

The air pump 108a is an example of a high-pressure air generation unit included in the controller 100. The air pump 108a is, for example, a diaphragm type air pump. The air pump 108a is electrically connected to the control unit 101, and operates in response to a control signal from the control unit 101.

An upstream end of the first air feeding tube 108A is connected to an ejection port of the air pump 108a. A downstream end of the first air feeding tube 108A is connected to the head-side module 109 via an umbilical cable 71 included in the connection cable 1000. In the first air feeding tube 108A, the regulator 108b, the pressure sensor 108c, and the flow rate sensor 108d are arranged in this order from an upstream side to a downstream side.

The regulator 108b adjusts a pressure of the high-pressure air ejected from the air pump 108a to flow to a downstream side of the first air feeding tube 108A, and includes a pressure adjustment valve and the like. The regulator 108b is an example of an air pressure adjusting unit that is included in the controller 100 and regulates the pressure of the high-pressure air generated by the air pump 108a.

The air whose pressure is adjusted by the regulator 108b is an example of the high-pressure air. The high-pressure air referred to herein is not particularly limited as long as the high-pressure air has a pressure higher than an atmospheric pressure. For example, the high-pressure air is an air of 100 kPa or more and 300 kPa or less, more specifically, an air of 150 kPa or more and 250 kPa or less. As an example, in the present embodiment, a high-pressure air of slightly less than 200 kPa flows to the downstream side of the first air feeding tube 108A.

The pressure sensor 108c detects a pressure state of the high-pressure air regulated by the regulator 108b. The flow rate sensor 108d detects a flow rate of the high-pressure air regulated by the regulator 108b. Each of the pressure sensor 108c and the flow rate sensor 108d is electrically connected to the control unit 101, and inputs a detection signal thereof to the controller 100.

An upstream end of the second air feeding tube 108B is connected to a portion of the first air feeding tube 108A between the air pump 108a and the regulator 108b. A downstream end of the second air feeding tube 108B is connected to the head-side module 109 via the umbilical cable 71 included in the connection cable 1000. The twenty-ninth valve V29 is arranged in the middle of the second air feeding tube 108B. The twenty-ninth valve V29 is an opening and closing valve (electromagnetic valve) that opens or closes a flow path of the second air feeding tube 108B.

Although described in detail later, the drain tube 108C is a member for draining condensed water contained in the high-pressure air, and the drain tube 108C constitutes a drain passage. An upstream end of the drain tube 108C is connected to the head-side module 109 via the umbilical cable 71. A downstream end of the drain tube 108C is arranged on the controller 100 side, and the condensed water of the head-side module 109 is discharged to the controller 100 side. The thirtieth valve V30 is arranged in the middle of the drain tube 108C. The thirtieth valve V30 is a drain opening and closing valve (electromagnetic valve) that opens or closes a flow path (drain passage) of the drain tube 108C.

The head-side module 109 includes, as tube elements, a first air receiving tube 109A, a second air receiving tube 109B, a drain tube 109C, and a high-pressure air supply tube 109D. Each of the first air receiving tube 109A and the second air receiving tube 109B is an example of an air reception unit that receives the high-pressure air.

The head-side module 109 further includes a removing unit 109a that removes the condensed water contained in the high-pressure air received by the first air receiving tube 109A, an air jetting unit 109b, an air opening 109c, and a twenty-second valve V22.

An upstream end of the first air receiving tube 109A is connected to the downstream end of the first air feeding tube 108A via the umbilical cable 71. That is, the first air receiving tube 109A receives the high-pressure air generated by the controller 100 via the connection cable 1000 that fluidly and electrically connects the print head 1 and the controller 100. A downstream end of the first air receiving tube 109A is connected to an air inlet 109e of the removing unit 109a. Thus, the high-pressure air generated by the air pump 108a flows into the air inlet 109e of the removing unit 109a via the first air feeding tube 108A and the first air receiving tube 109A.

The condensed water may be contained in the high-pressure air compressed by the air pump 108a. A portion for removing the condensed water is the removing unit 109a, and the removing unit 109a is formed by using a member capable of removing the condensed water contained in the high-pressure air received by the first air receiving tube 109A. The removing unit 109a of the present embodiment is a member that removes the condensed water contained in the high-pressure air by pressurizing the high-pressure air received by the first air receiving tube 109A. More specifically, the removing unit 109a includes a water-repellent air flow path 109g having fine pores, pressurizes the high-pressure air flowing through the water-repellent air flow path 109g, and takes out the high-pressure air in the water-repellent air flow path 109g via the fine pores in a state where the condensed water gathers in the water-repellent air flow path 109g.

The entire removing unit 109a is housed in an airtight compartment 110. The high-pressure air flowing out from the fine pores of the removing unit 109a flows out only into the airtight compartment 110.

An upstream end of the high-pressure air supply tube 109D is connected to the airtight compartment 110. The air jetting unit 109b that jets the high-pressure air from which the condensed water is removed by the removing unit 109a is connected to a downstream end of the high-pressure air supply tube 109D. The air jetting unit 109b is, for example, an air nozzle. The twenty-second valve V22 including an electromagnetic valve that controls the flow rate of the high-pressure air is arranged in the middle of the high-pressure air supply tube 109D. The twenty-second valve V22 is an electromagnetic valve arranged in the middle of an air path from the air pump 108a to the air jetting unit 109b. The twenty-second valve V22 is controlled by the controller 100, and the high-pressure air is jetted from the air jetting unit 109b by opening and closing control of the twenty-second valve V22.

An upstream end of the drain tube 109C is connected to a condensed water flow outlet 109f of the removing unit 109a. A downstream end of the drain tube 109C is connected to the upstream end of the drain tube 108C via the umbilical cable 71. That is, the drain tube 108C is provided on a downstream side of the water-repellent air flow path 109g and constitutes a drain passage for discharging the condensed water gathering in the water-repellent air flow path 109g.

A downstream end of the second air receiving tube 109B is connected to the upstream end of the second air feeding tube 108B via the umbilical cable 71. The downstream end of the second air receiving tube 109B is connected to the air opening 109c for releasing air having a pressure lower than that of the high-pressure air into the print head 1. That is, the print head 1 has the air opening 109c for releasing a gas-liquid mixed air inside the print head 1. When the twenty-ninth valve V29 is opened in a state where the air pump 108a is operated, a low-pressure air is supplied from the air opening 109c.

As illustrated in FIG. 4B, the air jetting unit 109b is arranged on the first electrode plate 151 so as to jet air toward the second electrode plate 152. The air jetting unit 109b is embedded in the first electrode plate 151 and opens on a surface facing the second electrode plate 152. The opening of the air jetting unit 109b faces the second electrode plate 152.

A jetting axis Aa of air in the air jetting unit 109b extends toward the second electrode plate 152 of the deflection electrode 15 as illustrated in FIG. 4B. In other words, the jetting axis Aa of the high-pressure air intersects with the second electrode plate 152 as illustrated in FIG. 4B.

Note that the "jetting axis Aa of the air" referred to herein refers to a central axis of the high-pressure air jetted from the air jetting unit 109b. That is, the fact that the jetting axis Aa of the high-pressure air extends toward the second electrode plate 152 indicates that the air jetting unit 109b according to the present embodiment jets the high-pressure air toward the deflection electrode 15, particularly toward the second electrode plate 152.

The jetting axis Aa of the high-pressure air in the air jetting unit 109b intersects with the flight axis Ax as illustrated in FIG. 4B. That is, the air jetting unit 109b according to the present embodiment is arranged such that the flight axis Ax of the solvent spouting from the print nozzle 12 is interposed between the air jetting unit 109b and the deflection electrode 15, particularly, the second electrode plate 152.

In the head cleaning, the control unit 101 operates the air pump 108a in a state where the twenty-second valve V22, the thirtieth valve V30, and the twenty-ninth valve V29 are closed. Accordingly, the air pressure can be increased. The twenty-second valve V22 is opened in a state where the pressure of the air is increased, and thus, the high-pressure air is jetted from the air jetting unit 109b.

Here, as illustrated by reference numeral M1 in FIG. 4B, the air jetting unit 109b causes the high-pressure air to intersect with the flight axis Ax of the solvent ejected or jetted in the print head 1. The air jetting unit 109b diffuses the solvent into the print head 1 by causing the high-pressure air to intersect with the flight axis Ax. Specifically, in the example illustrated in FIG. 4B, the flight axis Ax of the solvent ejected or spouting from the print nozzle 12 is interposed between the air jetting unit 109b and the second electrode plate 152, and the flight axis Ax and the jetting axis Aa of the air intersect with each other. Therefore, the high-pressure air (indicated by reference numeral M1 in FIG. 4B) jetted along the jetting axis Aa can be applied to the shaft-shaped solvent spouting from the print nozzle 12 along the flight axis Ax or a drop-shaped solvent spouting from the print nozzle 12.

The air jetting unit 109b can also turn the solvent into mist by applying the high-pressure air to the shaft-shaped solvent. Specifically, the air jetting unit 109b turns the solvent into mist as indicated by reference numeral M1 in FIG. 4B by applying the jetted high-pressure air to the solvent supplied from the solvent supply unit 105.

The turning of the solvent into mist by the air jetting module 3A is realized by increasing the pressure of the air. Furthermore, the high-pressure air hits the solvent spouting along the flight axis Ax and then collides with the second electrode plate 152. The air is caused to collide with the second electrode plate 152, and thus, dirt adhering to the second electrode plate 152 is easily removed. Furthermore, the solvent is turning into mist, and thus, a cleaning region of the component by the solvent is enlarged as compared with a case where the solvent is not turned into mist. The solvent turned into mist by collision with the high-pressure air is applied to the second electrode plate 152, and thus, it is possible to clean each component disposed around the second electrode plate 152 including the second electrode plate, that is, each component in the print head 1. The cleaning by the solvent is particularly effective for dirt caused by ink, for example.

Whether or not the solvent can be turned into mist as intended depends on an outflow state of the high-pressure air flowing out in the print head 1. Accordingly, in the present embodiment, the outflow state of the high-pressure air flowing out in the print head 1 can be detected. The inkjet recording device I includes the pressure sensor 108c and the flow rate sensor 108d that function as an air outflow state detection unit that detects the outflow state of the high-pressure air flowing out in the print head 1. Since the pressure sensor 108c and the flow rate sensor 108d are provided in the controller 100, these sensors detect the outflow state of the high-pressure air before being jetted by the air jetting unit 109b. More specifically, since the pressure sensor 108c and the flow rate sensor 108d are arranged on a downstream side of the regulator 108b, a state of the high-pressure air regulated by the regulator 108b is detected as the outflow state of the high-pressure air.

That is, the pressure sensor 108c detects the pressure state of the high-pressure air regulated by the regulator 108b, as the outflow state of the high-pressure air. Furthermore, the flow rate sensor 108d detects the flow rate of the high-pressure air regulated by the regulator 108b, as the outflow state of the high-pressure air.

In this embodiment, since the twenty-second valve V22 is provided between the air pump 108a and the air jetting unit 109b, the twenty-second valve V22 is in the closed state to increase a pressure between the air pump 108a and the twenty-second valve V22 when the flow rate sensor 108d detects the flow rate of the high-pressure air. The twenty-second valve V22 may be provided on the print head 1 side or may be provided on the controller 100 side. However, in consideration of a flow path resistance from the controller 100 to the print head 1, it may be preferable that the valve is provided in the vicinity of the air jetting unit 109b. That is, when the twenty-second valve V22 is opened after the pressure is preserved in the path itself between the air pump 108a and the air jetting unit 109b, the force immediately after the opening of the twenty-second valve V22 can be effectively used.

In a procedure in which the twenty-second valve V22 is changing from the closed state to the opened state, the pressure state of the high-pressure air can be detected by the pressure sensor 108c. First, when the pressure is low when the air pump 108a is in operation with the twenty-second valve V22 in the closed state, there is a possibility that a path to the air pump 108a or the pressure sensor 108c is blocked. Furthermore, when the pressure is too high when the twenty-second valve V22 is in the opened state, there is a possibility that the air jetting unit 109b is narrowed.

Furthermore, when the flow rate sensor 108d when the twenty-second valve V22 is in the closed state detects a certain flow rate or more, the twenty-second valve V22 and other paths (such as valves V27 to V30) are not closed, and there is a possibility that leakage occurs. When the flow rate sensor 108d does not detect the certain flow rate or more when the twenty-second valve V22 is in the opened state, there is a possibility that the air jetting unit 109b is narrowed.

As described above, the pressure sensor 108c detects the pressure state of the high-pressure air when the twenty-second valve V22 is in the opened state and the pressure state of the high-pressure air when the twenty-second valve is in the closed state. Furthermore, the flow rate sensor 108d detects the flow rate of the high-pressure air when the twenty-second valve V22 is in the opened state and the flow rate of the high-pressure air when the twenty-second valve V22 is in the closed state. As a result, the control unit 101 can determine whether or not the air jetting unit 109b is narrowed. When it is determined that there is a possibility that the air jetting unit 109b is narrowed or when it is determined that the ejection amount of the air pump 108a is abnormal, the control unit 101 displays error information on the display unit 103a or the like so as not to perform the cleaning operation using the high-pressure air.

The control unit 101 includes the cleaning control unit 101a as a functional element for controlling head cleaning by the solvent supply unit 105, the air jetting module 3A, and the cleaning and placing unit 200. By the control performed by the cleaning control unit 101a, at least one of a timing at which the solvent supply unit 105 ejects or jets the solvent in the print head 1 and a timing at which the air jetting module 3A intersects the flight axis Ax with the high-pressure air is adjusted. With this adjustment, the air jetting module 3A causes the high-pressure air to intersect with the flight axis Ax. Specifically, under the control of the cleaning control unit 101a, both the timing at which the solvent supply unit 105 ejects or jets the solvent in the print head 1 and the timing at which the air jetting module 3A causes the flight axis Ax to intersect with the high-pressure air are adjusted.

Here, the cleaning control unit 101a can control the timing at which the solvent in the print head 1 is ejected or jetted via a valve opening timing of the twelfth valve V12 as a solvent control valve. Furthermore, the cleaning control unit 101a can also adjust the timing at which the high-pressure air intersects with the flight axis Ax via the valve opening timing of the twenty-second valve V22.

Furthermore, when the high-pressure air is jetted, the cleaning control unit 101a can also operate the shutter 21 to close the ejection port 10a (to be described later). As a result, solvent leakage from the print head 1, particularly the housing 10 is suppressed.

FIG. 4A illustrates a cleaning operation of cleaning the print nozzle 12, the gutter 16, and the like by ejecting the solvent from the print nozzle 12 in a shaft shape along the flight axis Ax. In the cleaning operation illustrated in FIG. 4A, the shutter 21 is set to the opened state. This cleaning operation is included in an in-line cleaning operation of cleaning at least one component of the print nozzle 12, the charging electrode 13, the deflection electrode 15, and the gutter 16 in a state where the print head 1 is installed at the installation location of the print head 1 when printing is performed by the inkjet recording device I. In this case, the print nozzle 12 may be a first cleaning unit.

FIG. 4B illustrates a cleaning operation of cleaning the charging electrode 13, the deflection electrode 15, and the like by jetting air toward the shaft-shaped solvent ejected from the print nozzle 12 to turn the solvent into mist. In the cleaning operation illustrated in FIG. 4B, the shutter 21 is set to the opened state. This cleaning operation is included in the in-line cleaning operation of cleaning at least one component of the print nozzle 12, the charging electrode 13, the deflection electrode 15, and the gutter 16 in a state where the print head 1 is installed at the installation location of the print head 1 when printing is performed by the inkjet recording device I. In this case, the print nozzle 12 and the air jetting unit 109b can serve as the first cleaning unit. As described above, the air jetting unit 109b is used as a cleaning nozzle.

The amount of air jetted from the air jetting unit 109b can be adjusted by the cleaning control unit 101a. The amount of air jetted from the air jetting unit 109b is adjusted such that the solvent turned into misted reaches the charging electrode 13, the deflection electrode 15, and the like. In a case where the amount of the shaft-like solvent is adjusted, the amount of air can be adjusted so as to be the amount of air corresponding to the amount of the shaft-like solvent.

The controller 100 includes a cleaning management unit 101d (see FIG. 2) that manages the use amount of solvent supplied at the time of the in-line cleaning operation by the cleaning control unit 101a. The cleaning management unit 101d manages the use amount of solvent at the time of head cleaning such that the amount of solvent corresponding to the high-pressure air jetted from the air jetting unit 109b is supplied. That is, the cleaning management unit 101d manages the use amount of solvent at the time of head cleaning such that the amount of solvent corresponding to the air jetted from the air jetting unit 109b is supplied and leakage of the solvent from the ejection port 10a is suppressed. For example, the cleaning management unit 101d executes processing of filling the solvent up to the solvent supply tube 54 on the upstream side of the twelfth valve V12 and processing of discharging the solvent from the solvent supply tube 54 on the downstream side of the twelfth valve V12. As a result, since the amount of solvent flowing per unit time on the jetting axis Aa line of the air jetting unit 109b can be controlled, a fixed amount of solvent can be used as much as possible in head cleaning, and as a result, the use amount of solvent at the time of head cleaning is controlled. Accordingly, it is possible to suppress the leakage of the solvent from the ejection port 10a at the time of head cleaning.

FIG. 4C illustrates a cleaning operation of jetting a first predetermined amount of solvent from the cleaning nozzle 17 toward the print nozzle 12, the charging electrode 13, the deflection electrode 15, and the like to clean the charging electrode 13, the deflection electrode 15, and the like. As described above, the cleaning nozzle 17 is provided in the head body 1A, and ejects the solvent toward the head module 1B. The cleaning nozzle 17 may be provided in the head module 1B. In this case, the cleaning nozzle 17 provided in the head module 1B ejects the solvent toward the head body 1A.

In the cleaning operation illustrated in FIG. 4C, the shutter 21 is set to the opened state. The cleaning nozzle 17 may jet the solvent toward both the charging electrode 13 and the deflection electrode 15, or may jet the solvent toward only one of the charging electrode 13 and the deflection electrode 15. The cleaning nozzle 17 may jet the solvent toward only one of the charging electrode 13 and the deflection electrode 15, and then jet the solvent toward the other. The number of cleaning nozzles 17 is not limited to one, and may be plural. The cleaning nozzle 17 may include a cleaning nozzle that jets the solvent to the charging electrode 13 and a cleaning nozzle that jets the solvent to the deflection electrode 15.

The cleaning operation illustrated in FIG. 4C is included in the in-line cleaning operation of cleaning at least one component of the print nozzle 12, the charging electrode 13, the deflection electrode 15, and the gutter 16 in a state where the print head 1 is installed at the installation location of the print head 1 when printing is performed by the inkjet recording device I. In this case, the cleaning nozzle 17 can be the first cleaning unit.

The cleaning management unit 101d manages the use amount of solvent jetted from the cleaning nozzle 17 at the time of the cleaning operation illustrated in FIG. 4C. The cleaning management unit 101d manages the use amount of solvent jetted from the cleaning nozzle 17 so as to suppress the leakage of the solvent from the ejection port 10a.

The cleaning operation illustrated in FIG. 4C can be executed when start-up processing is executed. That is, as illustrated in FIG. 2, the control unit 101 of the controller 100 includes a start-up processing execution unit 101f. The start-up processing execution unit 101f is a portion that executes start-up processing of achieving a printable state by collecting ink continuously ejected from the print nozzle 12 in the print head 1 by the gutter 16. The cleaning operation illustrated in FIG. 4C is executed when the start-up processing is executed, and thus, the components of the print head 1 can be automatically cleaned by using the cleaning nozzle 17. The order of the cleaning operation and the start-up processing is the cleaning operation first. That is, the start-up processing execution unit 101f executes the start-up processing after automatically cleaning the components of the print head 1 by using the cleaning nozzle 17 by executing the cleaning operation illustrated in FIG. 4C.

After a predetermined period elapses since the components of the print head 1 are automatically cleaned by using the cleaning nozzles 17, the start-up processing execution unit 101f executes the start-up processing. The predetermined period elapses after the cleaning, and thus, the inside of the housing 10 can be dried. The predetermined period can be, for example, about 1 minute, but is not limited thereto, and may be any period as long as the inside of the housing 10 can be dried. The air opening 109c is used at the time of drying. The completion of the dry processing using the air opening 109c may be notified to the user by the display unit 103a, a speaker, or the like. In this case, a message or a drawing indicating that the inside of the housing 10 is dried is displayed on the display unit 103a.

When the ink adheres to the shutter 21 and solidifies, there is a risk that the shutter 21 becomes stuck and fails. In order to prevent this failure of the shutter 21, the control unit 101 periodically opens or closes the shutter 21 so as not to be stuck at the time of drying using the air opening 109c. That is, the control unit 101 executes an opening and closing operation of the shutter 21 at the time of drying using the air opening 109c as preventive processing for preventing the failure of the shutter 21. The preventive processing may be executed before drying using the air opening 109c or after drying using the air opening 109c. Furthermore, the shutter 21 may be opened and closed in a state of being immersed in the solvent.

The control unit 101 of the controller 100 includes a reception unit 101h. The reception unit 101h can receive a start-up processing start instruction. For example, when the user performs a start-up start operation by using the operation unit 103b, the reception unit 101h receives the start-up processing start instruction. The cleaning control unit 101a automatically cleans the components of the print head 1 by executing the cleaning operation illustrated in FIG. 4C when the reception unit 101h receives the start-up processing start instruction and the start-up processing is executed.

Furthermore, the reception unit 101h can also receive a signal indicating the start-up processing start instruction from an external remote control device. The external remote control device is, for example, an instruction device or the like connected via the PLC 903 or a signal line. In this case, the cleaning control unit 101a executes the cleaning processing based on the signal received by the reception unit 101h.

As described above, after the components of the print head 1 are automatically cleaned by using the cleaning nozzle 17, the control unit 101 executes the dry processing of drying the inside of the print head 1 by using the air opening 109c. Thereafter, the start-up processing execution unit 101f executes the start-up processing of achieving a printable state by collecting the ink continuously ejected from the print nozzle 12 in the print head 1 by the gutter 16.

FIG. 4D illustrates a cleaning operation (reserving cleaning processing) in which the shutter 21 is in the closed state to block the ink ejection port 10a, then the solvent is reserved in the housing 10, and the deflection electrode 15, the gutter 16, and the like are cleaned by the solvent reserved in the housing 10. For example, the solvent may be jetted from the cleaning nozzle 17, may be jetted from the print nozzle 12, or may be jetted from a dedicated nozzle (not illustrated) that jets the solvent to be reserved in the housing 10. The amount of solvent reserved in the housing 10 is not particularly limited, but can be, for example, an amount by which the deflection electrode 15 is immersed in the solvent. That is, the supply amount of solvent can be set such that the liquid level of the solvent is higher than that of the deflection electrode 15.

The liquid level of the solvent may be positioned above an upper end of the deflection electrode 15, or may be positioned below the upper end of the deflection electrode 15 and above a lower end of the deflection electrode 15. Furthermore, the liquid level of the solvent may be positioned at least above the opening 16a of the gutter 16. The solvent reserved in the housing 10 is collected from the solvent collection port 10b and sent to the controller 100.

The cleaning operation illustrated in FIG. 4D is included in the in-line cleaning operation of cleaning at least one component of the print nozzle 12, the charging electrode 13, the deflection electrode 15, and the gutter 16 in a state where the print head 1 is installed at the installation location of the print head 1 when printing is performed by the inkjet recording device I. In this case, the cleaning nozzle 17, the print nozzle 12, and the dedicated nozzle that supply the solvent into the housing 10 can be the first cleaning unit.

FIG. 4E illustrates a cleaning operation of jetting a second predetermined amount of solvent from the cleaning nozzle 17 toward the charging electrode 13, the deflection electrode 15, and the like to clean the charging electrode 13, the deflection electrode 15, and the like. In the cleaning operation illustrated in FIG. 4E, the shutter 21 is set to the opened state. The second predetermined amount is set to be smaller than the first predetermined amount jetted at the time of the cleaning operation illustrated in FIG. 4C. That is, in the present embodiment, cleaning is performed by changing the state of the solvent ejected from the cleaning nozzle 17 in a state where the print head 1 is installed at the installation location of the print head 1 when printing is performed by the inkjet recording device I. The state of the solvent is the ejection amount of solvent per unit time, a pressure at the time of spouting the solvent, a spouting range of the solvent, and the like, and it is also possible to perform cleaning by changing only any one of the ejection amount, the pressure, and the jetting range, or by changing a plurality of any ones. For example, the ejection amount of solvent per unit time can be changed from a first spouting amount to a second spouting amount, the pressure at the time of spouting the solvent can be changed from a first pressure to a second pressure, or the spouting range of the solvent can be changed from a first spouting range to a second spouting range.

At the time of the cleaning operation illustrated in FIG. 4E, the cleaning nozzle 17 may jet the solvent toward both the charging electrode 13 and the deflection electrode 15, or may jet the solvent toward only one of the charging electrode 13 and the deflection electrode 15. The cleaning nozzle 17 may jet the solvent toward only one of the charging electrode 13 and the deflection electrode 15, and then jet the solvent toward the other.

The cleaning operation illustrated in FIG. 4E is included in the in-line cleaning operation of cleaning at least one component of the print nozzle 12, the charging electrode 13, the deflection electrode 15, and the gutter 16 in a state where the print head 1 is installed at the installation location of the print head 1 when printing is performed by the inkjet recording device I. In this case, the cleaning nozzle 17 can be the first cleaning unit.

The cleaning management unit 101d manages the use amount of solvent jetted from the cleaning nozzle 17 at the time of the cleaning operation illustrated in FIG. 4E. The cleaning management unit 101d manages the use amount of solvent jetted from the cleaning nozzle 17 so as to suppress the leakage of the solvent from the ejection port 10a.

FIG. 4F illustrates a cleaning operation of cleaning the components of the print head 1 by using the cleaning and placing unit 200. That is, as illustrated in FIG. 1, the inkjet recording device I includes the cleaning and placing unit 200. The cleaning and placing unit 200 is arranged at a location different from the installation location of the print head 1 (the installation location of the print head 1 installed in the production line) when printing is performed by the inkjet recording device I.

The cleaning and placing unit 200 is configured such that the print head 1 is placed when the print head 1 is cleaned by using the solvent. The cleaning and placing unit 200 and the print head 1 are connected to be able to communicate with each other. Furthermore, the print head 1 and the controller 100 are connected to be able to communicate with each other. When the print head 1 is placed on the cleaning and placing unit 200, as illustrated in FIG. 4F, the solvent is jetted from the cleaning nozzle 17 toward the charging electrode 13, the deflection electrode 15, and the like to clean the charging electrode 13, the deflection electrode 15, and the like. In the cleaning operation illustrated in FIG. 4F, the shutter 21 is set to the opened state. Since the print head 1 is placed on the cleaning and placing unit 200, even though the solvent leaks from the ejection port 10a of the housing 10, the solvent can be received by the cleaning and placing unit 200. In the cleaning operation illustrated in FIG. 4F, the cleaning and placing unit 200 is a member on which the print head 1 is placed when the components of the print head 1 are cleaned, and may be a second cleaning unit.

FIG. 4G illustrates another example of the cleaning operation of cleaning the components of the print head 1 by using the cleaning and placing unit 200. A solvent ejection nozzle 201 for ejecting the solvent supplied from the controller 100 is provided in the cleaning and placing unit 200. The solvent ejection nozzle 201 is a nozzle that ejects the solvent from an introduction port 10c formed in the housing 10 toward the charging electrode 13, the deflection electrode 15, and the like, and corresponds to a second solvent ejection nozzle. The solvent ejection nozzle 201 can also eject the solvent toward, for example, the cleaning nozzle 17 or the print nozzle 12. As a result, the cleaning nozzle 17 and the print nozzle 12 can be cleaned.

The second solvent ejection nozzle included in the cleaning and placing unit 200 may be a nozzle that ejects the solvent supplied from the controller 100 via the head body 1A. The second solvent ejection nozzle is directed to at least a part of a contact portion where the head module 1B is in contact with the head body 1A. As a result, the second solvent ejection nozzle ejects the solvent to at least a part of the contact portion where the head module 1B is in contact with the head body 1A. That is, when the ink adheres to the contact portion where the head module 1B is in contact with the head body 1A, there is a risk that the head module 1B adheres to the head body 1A due to the solidification of the ink. However, the second solvent ejection nozzle ejects the solvent to at least a part of the contact portion, and thus, the ink at the contact portion can be washed away. As a result, the head module 1B is prevented from adhering to the head body 1A.

At the time of the cleaning operation illustrated in FIG. 4G, the solvent ejection nozzle 201 may jet the solvent toward both the charging electrode 13 and the deflection electrode 15, or may jet the solvent toward only one of the charging electrode 13 and the deflection electrode 15. The cleaning nozzle 17 may jet the solvent toward only one of the charging electrode 13 and the deflection electrode 15, and then jet the solvent toward the other. In the cleaning operation illustrated in FIG. 4G, the shutter 21 is set to the opened state. In the cleaning operation illustrated in FIG. 4G, the cleaning and placing unit 200 is a member on which the print head 1 is placed when the components of the print head 1 are cleaned, and may be the second cleaning unit.

The cleaning and placing unit 200 includes a reserving unit 202 that reserves the solvent ejected from the solvent ejection nozzle 201 and immerses all or a part of the placed print head 1 with the solvent. At the time of the cleaning operation illustrated in FIG. 4G, the charging electrode 13 and the deflection electrode 15 can be immersed and cleaned by reserving the solvent ejected from the solvent ejection nozzle 201 in the reserving unit 202 of the cleaning and placing unit 200.

FIG. 4H illustrates a cleaning operation in which the shutter 21 is in the closed state to block the ink ejection port 10a and then the solvent is jetted into the housing 10. In the cleaning operation illustrated in FIG. 4H, the shutter 21 is in the closed state to block the ink ejection port 10a, and then the solvent is jetted from the cleaning nozzle 17 toward the charging electrode 13, the deflection electrode 15, and the like to clean the charging electrode 13, the deflection electrode 15, and the like. The amount of solvent ejected from the cleaning nozzle 17 is larger than that in the cleaning operation illustrated in FIG. 4C. Since the ink ejection port 10a is blocked, the solvent is reserved in the housing 10. A liquid level of the solvent at this time is lower than a liquid level of the solvent in the case of the immersion cleaning illustrated in FIG. 4D. That is, in the cleaning operation illustrated in FIG. 4H, the components of the print head 1 are cleaned by using an amount of solvent that is less than the solvent used in the immersion cleaning. The solvent reserved in the housing 10 is collected from the solvent collection port 10b and sent to the controller 100.

The cleaning operation illustrated in FIG. 4H is included in the in-line cleaning operation of cleaning at least one component of the print nozzle 12, the charging electrode 13, the deflection electrode 15, and the gutter 16 in a state where the print head 1 is installed at the installation location of the print head 1 when printing is performed by the inkjet recording device I. In this case, the cleaning nozzle 17 that supplies the solvent into the housing 10 can serve as the first cleaning unit.

As illustrated in FIGS. 4A-4H, the inkjet recording device I includes a plurality of cleaning units that clean at least one component of the print nozzle 12, the charging electrode 13, the deflection electrode 15, and the gutter 16 by a plurality of different cleaning methods by using the solvent supplied from the solvent supply unit 105.

The control unit 101 of the controller 100 includes the cleaning control unit 101a that controls a plurality of cleaning units such that the components of the print head 1 are cleaned by a specific cleaning method among a plurality of different cleaning methods. The first cleaning unit includes the print nozzle 12, the cleaning nozzle 17, the air jetting unit 109b, and the like. Furthermore, the cleaning and placing unit 200 is included as the second cleaning unit. As illustrated in FIGS. 4F and 4G, in a state where the print head 1 is placed on the cleaning and placing unit 200, even though the use amount of the solvent is large, since the solvent does not leak to the outside, the cleaning and placing unit 200 as the second cleaning unit cleans the components of the print head 1 with higher cleaning power than the print nozzle 12, the cleaning nozzle 17, the air jetting unit 109b, and the like as the first cleaning unit. As described above, the inkjet recording device I does not simply include the plurality of cleaning units, but includes a plurality of cleaning units having different cleaning capabilities.

The cleaning nozzle 17 has a first cleaning aspect of cleaning the component of the print head 1 in the opened state of the shutter 21 as illustrated in FIGS. 4C and 4E, and a second cleaning aspect of cleaning the component of the print head 1 in the closed state of the shutter 21 as illustrated in FIGS. 4D and 4H. In the case of the cleaning operation illustrated in FIG. 4D according to the second cleaning aspect, the components of the print head 1 are immersed in the solvent. As a result, the second cleaning aspect can perform cleaning with a higher cleaning capability than the first cleaning aspect.

The first cleaning unit and the second cleaning unit are individually controlled, and thus, the cleaning control unit 101a can execute any one cleaning operation among the cleaning operations illustrated in FIGS. 4A -4G, and can clean the components of the print head 1 by switching from any one cleaning operation to another cleaning operation. At this time, the cleaning control unit 101a can repeatedly clean the components of the print head 1 using the first cleaning unit, repeatedly clean the components of the print head 1 using the second cleaning unit, and repeatedly clean the components of the print head 1 by using the first cleaning unit and the second cleaning unit alternately. As described above, the cleaning control unit 101a can control the plurality of cleaning units by switching the plurality of cleaning units in a stepwise manner.

When the plurality of cleaning units is switched in a stepwise manner, the cleaning control unit 101a can automatically switch from the cleaning unit that performs cleaning first to the cleaning unit that performs cleaning next. For example, after the cleaning operation by the first cleaning unit is continuously executed for a predetermined time, the cleaning operation by the first cleaning unit is paused, and the cleaning operation by the second cleaning unit is executed. Conversely, after the cleaning operation by the second cleaning unit is continuously executed for a predetermined time, the cleaning operation by the second cleaning unit may be paused, and the cleaning operation by the first cleaning unit may be executed.

When the cleaning unit is switched, the cleaning control unit 101a may receive a switching instruction of the cleaning unit by the user. In this case, the cleaning control unit 101a switches from the cleaning unit that performs cleaning first to the cleaning unit that performs cleaning next by receiving the switching instruction of the cleaning unit by the user. For example, when the cleaning control unit 101a receives the switching instruction of the cleaning unit by the user in a state where the cleaning operation by the first cleaning unit is being executed, the cleaning operation by the first cleaning unit is paused, and the cleaning operation by the second cleaning unit is executed. Conversely, when the cleaning control unit 101a receives the switching instruction of the cleaning unit by the user in a state where the cleaning operation by the second cleaning unit is being executed, the cleaning operation by the second cleaning unit is paused, and the cleaning operation by the first cleaning unit is executed.

For example, the cleaning control unit 101a may repeatedly execute the cleaning of the components of the print head 1 using at least one of the first cleaning unit and the second cleaning unit. Then, the cleaning control unit 101a determines whether or not a predetermined stop condition for stopping the cleaning is satisfied, and stops cleaning in a case where the predetermined stop condition is satisfied.

The predetermined stop condition may be based on predetermined setting information or may be setting information determined by the user. Examples of the predetermined setting information include the number of retries of the cleaning operation and a cleaning time. Examples of the setting information determined by the user include an allowable level of downtime (pause time of the production line). The setting information can be stored in the storage unit 102 or the like, for example.

The inkjet recording device I includes the display unit 103a, a lamp, and the like as a notification unit that notifies the user of the stop of cleaning in a case where the predetermined stop condition is satisfied. For example, in a case where it is determined that the predetermined stop condition is satisfied, the cleaning control unit 101a displays, on the display unit 103a, that the predetermined stop condition is satisfied by a message or a drawing, or turns on the lamp. The message or a drawing displayed on the display unit 103a indicates that cleaning is stopped. In addition, a speaker (notification unit) or the like may be provided in advance, and the user may be notified of the stop of cleaning by voice or the like. In a case where cleaning is stopped, a cleaning stop flag can be stored in, for example, the storage unit 102 or the like. On the other hand, in a case where cleaning is completed, a cleaning completion flag can be stored in the storage unit 102 or the like, for example. These flags can be used at the time of control by the control unit 101.

Furthermore, in a case where the cleaning operation is switched, after the cleaning control unit 101a switches from the cleaning unit that performs cleaning first to the cleaning unit that performs cleaning next, the control unit 101 determines whether or not cleaning is insufficient in the next cleaning unit. Whether or not cleaning is insufficient in the next cleaning unit can be determined by an error detection unit 101b, a determination unit 101e, and the like to be described later. When cleaning is insufficient in the next cleaning unit, the user is notified of the stop of cleaning by the display unit 103a, the speaker, or the like. In a case where the display unit 103a is used, a message or a drawing for stopping cleaning is displayed.

A posture sensor 24 is provided in the print head 1. The posture sensor 24 detects a posture of the print head 1. The posture sensor 24 is, for example, an acceleration sensor or a gravity sensor. The posture sensor 24 is electrically connected to the control unit 101, and inputs a detection signal to the control unit 101. The cleaning control unit 101a can change the head cleaning sequence based on the detection signal of the posture sensor 24. A target of which the sequence is changed includes, for example, the supply amount of solvent from the solvent supply unit 105. As a result, solvent leakage from the print head 1, particularly the housing 10 is suppressed. In a case where the print head 1 directs the ejection port 10a downward along the vertical direction, the air and the solvent can more reliably collide with each other. In this case, since the solvent is more reliably turned into mist, a larger amount of solvent is allowed to be turned into mist. Thus, the cleaning control unit 101a increases the supply amount of solvent.

On the other hand, in a case where the ejection port 10a of the print head 1 is directed along the horizontal direction or directed upward along the vertical direction, it is inconvenient to cause the air and the solvent to collide with each other. In this case, the turning of the solvent into mist is suppressed. When a smaller amount of solvent is turned into mist as much as the turning of the solvent into mist is suppressed, the solvent can be used without waste. Thus, the cleaning control unit 101a reduces the supply amount of solvent.

As illustrated in FIG. 2, the controller 100 includes the error detection unit 101b. The error detection unit 101b detects an error related to ink contamination of at least one of the print nozzle 12, the charging electrode 13, the deflection electrode 15, and the gutter 16 provided in the print head 1. The error detection unit 101b detects, as the error related to ink contamination, at least one of a clogging error of the print nozzle 12, an error of the deflection electrode 15, a contamination error in the print head 1, and an error of the charging electrode 13.

For example, as the error of the deflection electrode 15, there is an error in which the deflection electrode 15 is short-circuited due to ink contamination and the voltage drops. For example, the error detection unit 101b acquires the voltage of the deflection electrode 15, and thus, the error of the deflection electrode 15 can be detected. Furthermore, for the charging electrode 13, the error of the charging electrode 13 can be detected by the error detection unit 101b acquiring a detection value of the charging detection sensor 14.

There are various methods for error detection by the error detection unit 101b. For example, when the ink adheres to the deflection electrode 15 and the adhered ink greatly grows, the voltage may decrease. Then, the ink particles are not normally deflected, and thus, the printing is disturbed. At this time, the error of the deflection electrode 15 occurs. When the error of the deflection electrode 15 repeatedly occurs, a "contamination error in the print head" may occur.

Furthermore, the charge amount of negatively charged ink particles is measured by the charging detection sensor 14 immediately after the print nozzle 12. At this time, when the charging detection sensor 14 is contaminated, the charge amount cannot be measured, and a "charging sensor contamination error" occurs. As a result, when phase matching is not performed normally, a "phase matching error" occurs. Since both the deflection electrode 15 and the charging detection sensor 14 are provided in the print head 1, a factor of the errors is considered to be in the print head 1, and classified as errors caused by the print head 1.

An error having a possibility that the factor is in the print head 1 or another component can also be detected by the error detection unit 101b. For example, whether or not the ink is normally collected in the gutter 16 can be monitored by the gutter sensor 16b arranged around the gutter 16. That is, the error detection unit 101b can acquire the detection result of the gutter sensor 16b, and determine whether or not the ink is normally collected in the gutter 16 based on the acquired result. In a case where the ink is not collected in the gutter 16, a "nozzle clogging error" occurs in the middle of the start-up by the start-up processing execution unit 101f of the inkjet recording device I, and a "gutter sensor non-detection error" occurs after the inkjet recording device I is once started up by the start-up processing execution unit 101f. The start-up processing execution unit 101f is a portion that executes start-up processing of collecting the ink ejected from the print nozzle 12 in the gutter 16 and circulating the ink.

Examples of a factor that the ink is not collected in the gutter 16 include clogging of the print nozzle 12, a failure in normal movement of the first pump P1 and the fourth pump P4, and the like. The clogging error of the print nozzle 12 is the error of which the factor is in the print head 1, and the error in which the pumps P1 and P4 are not normally moving is the error of which the factor is in the component (the controller 100) other than the print head 1. It is not possible to specify whether the factor of these errors is in the print head 1 or another component. Thus, the error is classified as the error having the possibility that the factor is in the print head 1 or another component.

The error of which the factor is limited to the component other than the print head 1 can also be detected by the error detection unit 101b. Examples of the error of which the factor is limited to the component other than the print head 1 include an error when the ink pressure is low and an error when an ink pressure is high. A value of a pressure gauge 49 (illustrated in FIG. 2) arranged in the ink supply tube 44 becomes abnormal in the start-up state of the inkjet recording device I, and thus, these errors occur. The pressure gauge 49 can be provided, for example, in the sixth ink tube 44f of the ink supply tube 44.

Normally, in the start-up state of the inkjet recording device I, the ink pressure in the ink supply tube 44 is adjusted to a predetermined range in order to maintain normal ejection from the print nozzle 12. However, for example, the ink pressure in the ink supply tube 44 may greatly deviate from the predetermined range due to the influence of a defect in a pressure reducing valve or the like. For example, since the pressure reducing valve is present in the component other than the print head 1, such an error is classified as the error of which the factor is limited to the component other than the print head 1.

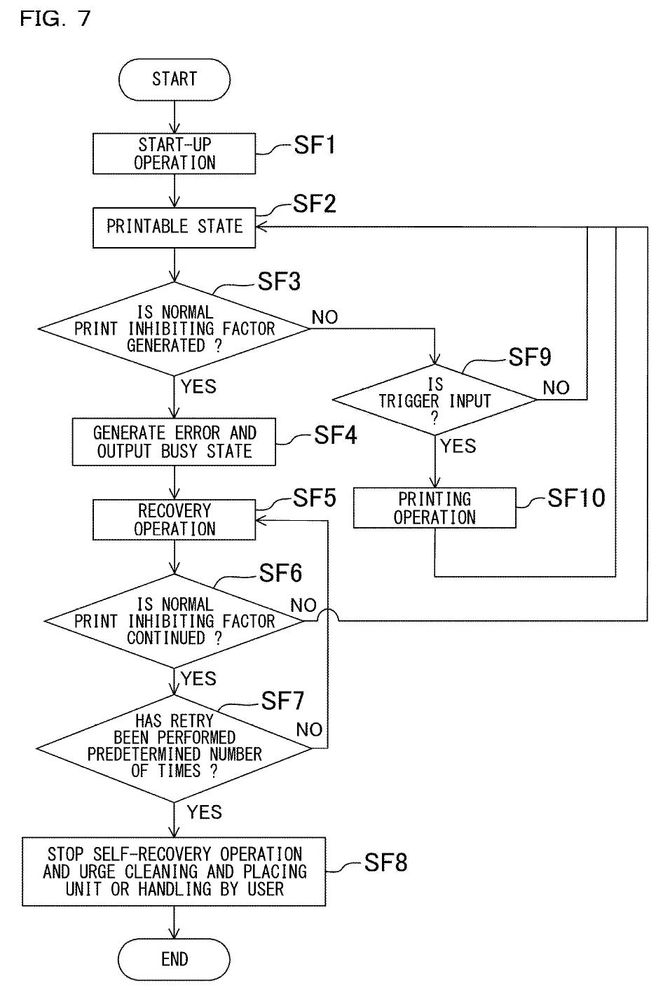

FIG. 7 is a flowchart illustrating processing in a case where an error is output even though a trigger is not input. After the start, in step SF1, the start-up processing execution unit 101f executes the start-up processing. In step SF2, the controller 100 and the print head 1 are brought into a printable state. In step SF3, the determination unit 101e determines whether or not the error detection unit 101b detects the error, that is, the above-described factor as a factor that hinders normal printing. In a case where the error detection unit 101b detects the error, the processing proceeds to step SF4, the error is generated, a busy state is set, and printing is not executed. In step SF5, a recovery operation such as cleaning is executed. In step SF6, it is determined whether or not the factor that hinders normal printing continues. In a case where the factor that hinders normal printing continues, the processing proceeds to step SF7, and it is determined whether or not the recovery operation of step SF5 is retried a predetermined number of times. In step SF8, in a case where the recovery operation is retried a predetermined number of times, a self-recovery operation is stopped, and the cleaning operation by the cleaning and placing unit 200 or the handling by the user is urged.

In a case where NO is determined in step SF3, the processing proceeds to step SF9, and it is determined whether or not a trigger output from the workpiece detection sensor 901 is input. In a case where the trigger output from the workpiece detection sensor 901 is not input, the processing returns to step SF2. In a case where the trigger output from the workpiece detection sensor 901 is input, the processing proceeds to step SF10, and the printing operation is executed.

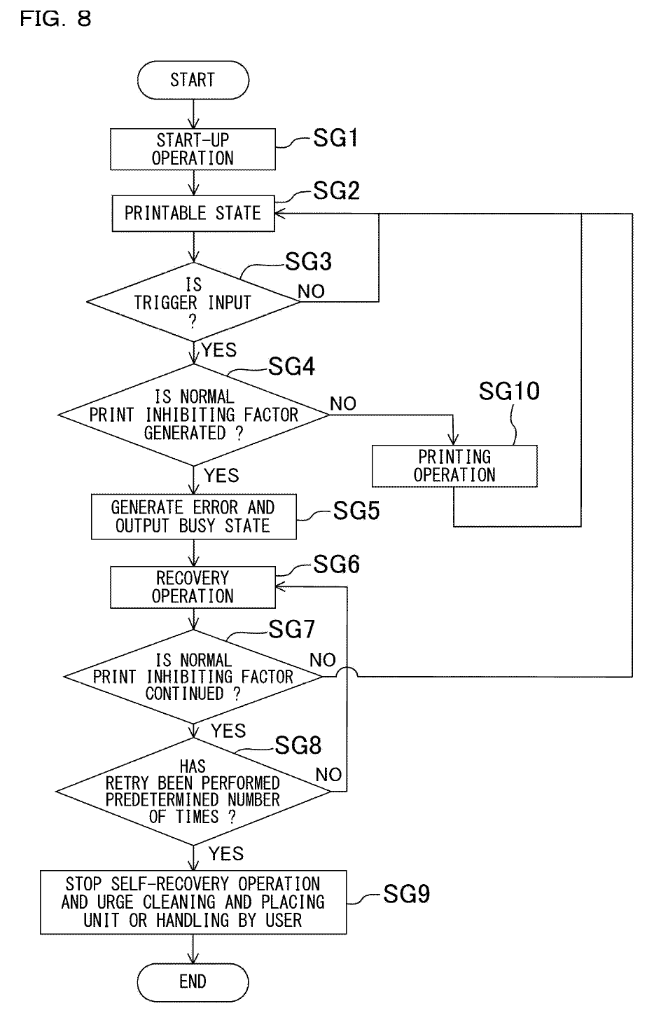

FIG. 8 is a flowchart illustrating processing in a case where the error is output after the trigger is input. After the start, in step SG1, the start-up processing execution unit 101f executes the start-up processing. In step SG2, the controller 100 and the print head 1 are brought into a printable state. In step SG3, it is determined whether or not the trigger output from the workpiece detection sensor 901 is input. In a case where the trigger output from the workpiece detection sensor 901 is not input, the processing returns to step SG2.

In a case where the trigger output from the workpiece detection sensor 901 is input, the processing proceeds to step SG4, and the determination unit 101e determines whether or not the error detection unit 101b detects the error, that is, the factor that hinders normal printing. In a case where the error detection unit 101b detects the error, the processing proceeds to step SG5, an error is generated, a busy state is set, and printing is not executed. In step SG6, a recovery operation such as cleaning is executed. In step SG7, it is determined whether or not the factor that hinders normal printing is continuing. In a case where the factor that hinders normal printing continues, the processing proceeds to step SG8, and it is determined whether or not the recovery operation of step SG6 is retried a predetermined number of times. In step SG9, in a case where the recovery operation is retried a predetermined number of times, a self-recovery operation is stopped, and the cleaning operation by the cleaning and placing unit 200 or the handling by the user is urged.

In a case where NO is determined in step SG4, the printing operation is executed, and the processing proceeds to step SG2. Furthermore, in a case where NO is determined in step SG7, the processing returns to step SG2.

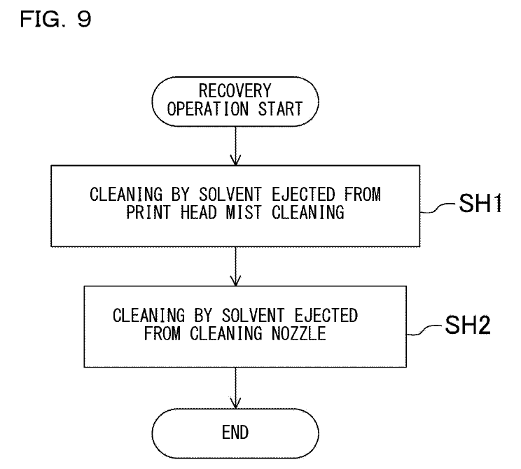

FIG. 9 is a flowchart of the recovery operation. After the start of the recovery operation, in step SH1, the cleaning control unit 101a executes a cleaning operation (cleaning operation illustrated in FIG. 4A) of ejecting the solvent in the shaft shape from the print nozzle 12 and mist cleaning (cleaning operation illustrated in FIG. 4B). In step SH1, only one of the cleaning operation of ejecting the solvent in the shaft shape from the print nozzle 12 and the mist cleaning may be executed. In step SH2, the cleaning control unit 101a executes a cleaning operation (cleaning operation illustrated in FIGS. 4C and 4E) by the solvent ejected from the cleaning nozzle 17. That is, the cleaning control unit 101a executes the cleaning operation having a relatively low cleaning capability and then executes the cleaning operation having a high cleaning capability.

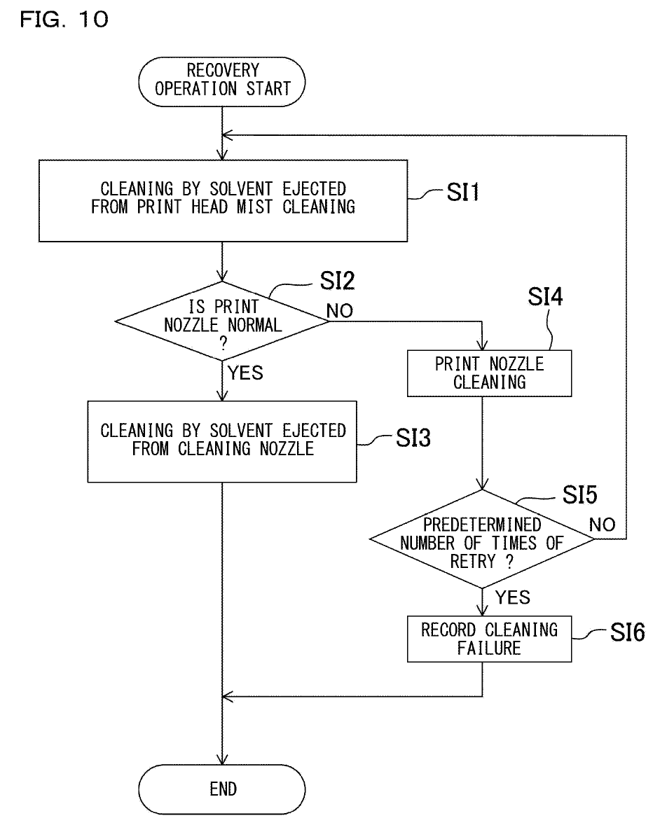

FIG. 10 is a flowchart illustrating details of the recovery operation. After the start of the recovery operation, in step SI1, the cleaning control unit 101a executes a cleaning operation (cleaning operation illustrated in FIG. 4A) of ejecting the solvent in the shaft shape from the print nozzle 12 and a mist cleaning (cleaning operation illustrated in FIG. 4B). In step SI1, only one of the cleaning operation of ejecting the solvent in the shaft shape from the print nozzle 12 and the mist cleaning may be executed. In step SI2, the cleaning control unit 101a determines whether or not the print nozzle 12 is normal, that is, whether or not the clogging error of the print nozzle 12 does not occur based on the detection result by the error detection unit 101b. In a case where the print nozzle 12 is normal, the processing proceeds to step SI3, and the cleaning control unit 101a executes a cleaning operation (cleaning operation illustrated in FIGS. 4C and 4E) by the solvent ejected from the cleaning nozzle 17.

On the other hand, in a case where the print nozzle 12 is clogged, the processing proceeds to step SI4, and the cleaning control unit 101a cleans the print nozzle 12. In step SI4, for example, as illustrated in FIG. 4C, the print nozzle 12 can be cleaned by ejecting the solvent in the shaft shape from the cleaning nozzle 17 toward the print nozzle 12.

In step SI5, the cleaning control unit 101a determines whether or not the cleaning operation of step SI1 and the cleaning operation of the print nozzle 12 of step SI4 are retried a predetermined number of times. When the cleaning operation of step SI1 and the cleaning operation of the print nozzle 12 of step SI4 are not retried a predetermined number of times, the processing proceeds to step SI1. On the other hand, in a case where the cleaning operation of step SI1 and the cleaning operation of the print nozzle 12 of step SI4 are retried a predetermined number of times, the processing proceeds to step SI6, and a failure in cleaning is recorded in the storage unit 102 or the like. The failure in cleaning is displayed on the display unit 103a or the like.

After cleaning, before or after drying using the air opening 109c, for example, the deflection voltage is applied to the deflection electrode 15, and the deflection voltage and the noise level of the charging detection sensor 14 at that time are measured. As a result, it is possible to detect that conductive dirt such as ink dirt disappears. In a case where it is determined that the conductive dirt is removed, it is determined that the cleaning succeeds, and the processing proceeds from step SI3 to the end.

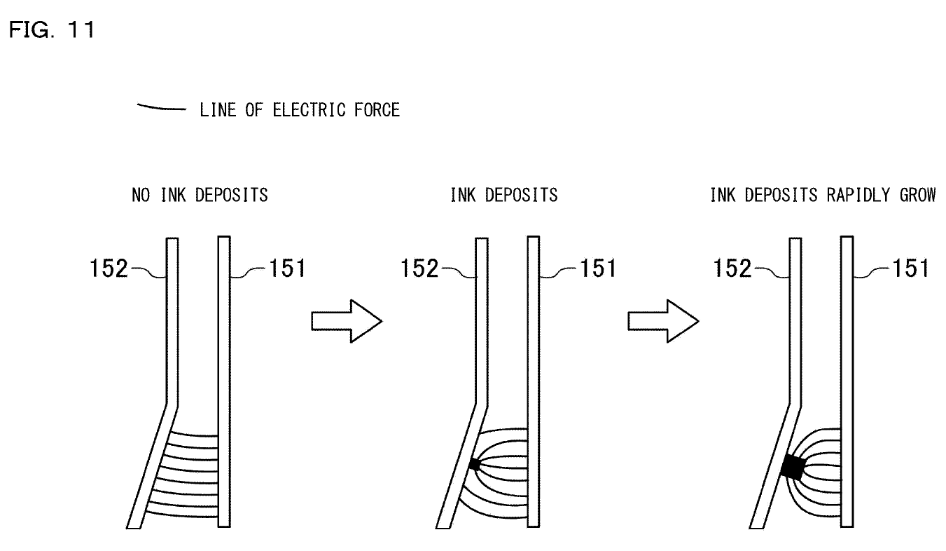

Here, the growth of ink deposits of the deflection electrode 15 will be described with reference to FIG. 11. In a case where there are no ink deposits of the deflection electrode 15, lines of electric force are formed at substantially equal intervals, but when the ink deposits are formed, the lines of electric force start to be disturbed even though the ink deposits are small. In particular, in the case of an inkjet printer, when the ink particles that land on the print object W are ejected from the print nozzle 12, extremely fine ink particles that do not contribute to printing are also formed, and the fine ink particles may adhere to the deflection electrode 15. As the ink deposited on the deflection electrode 15 further grows, since the deposited ink has conductivity, the lines of electric force gather on the deposited ink, and as a result, a printing error occurs. In order to avoid the occurrence of the printing error due to such ink deposits as much as possible, the inkjet recording device I according to the present embodiment has a preventive cleaning function.

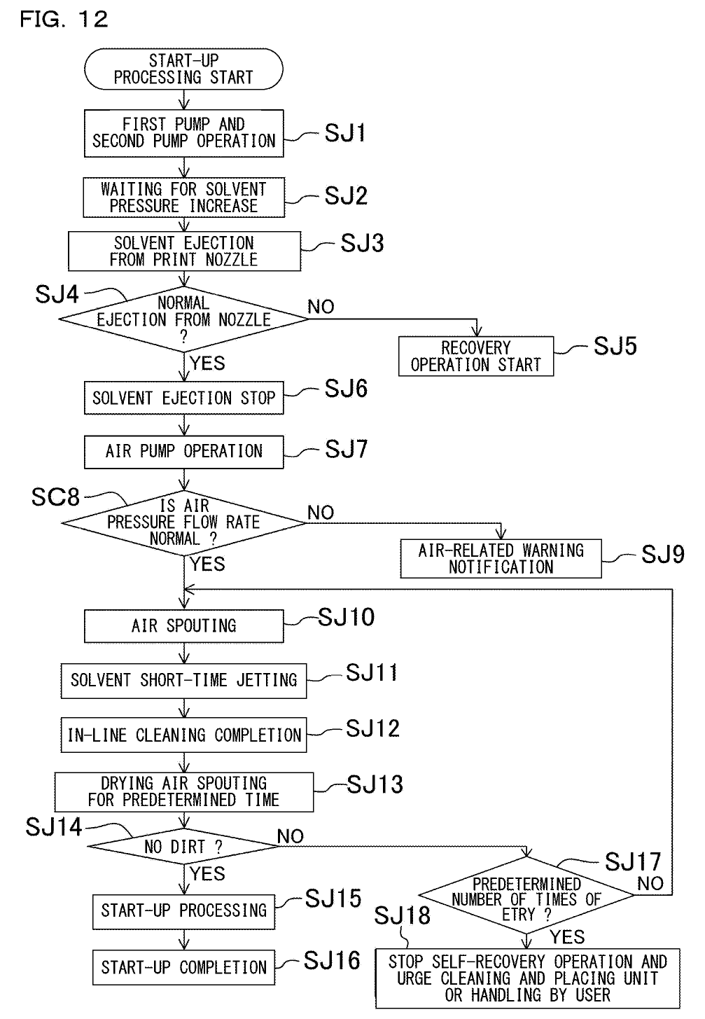

FIG. 12 is a flowchart illustrating preventive cleaning processing. This flowchart can be executed by the cleaning control unit 101a, and is started when the start-up processing by the start-up processing execution unit 101f is started. In step SJ1, the first pump P1 and the second pump P2 are operated. In step SJ2, the processing waits until a solvent pressure in the solvent supply tube 54 increases. In step SJ3, the solvent is ejected in the shaft shape from the print nozzle 12. In step SJ4, whether or not the solvent is normally ejected from the print nozzle 12 is determined based on, for example, a detection result or the like by the gutter sensor 16b. When the solvent is not normally ejected from the print nozzle 12, the processing proceeds to step SJ5 and the recovery operation described above is executed.

In a case where the solvent is normally ejected from the print nozzle 12, the processing proceeds to step SJ6 to pause the solvent ejecting. In step SJ7, the air pump 108a is operated. In step SJ8, it is determined whether or not the air pressure and the flow rate are normal based on the detection values of the pressure sensor 108c and the flow rate sensor 108d. When the air pressure and the flow rate are not normal, the processing proceeds to step SJ9 to notify the user of an air-related warning.

When the air pressure and the flow rate are normal, the processing proceeds to step SJ10, and the air is jetted from the air jetting unit 109b. In step SJ11, the solvent is jetted from the print nozzle 12 for a short time (for example, less than 1 second). As a result, in-line cleaning using the solvent turned into mist is executed. In step SJ12, the in-line cleaning operation is completed.

In step SJ13, drying air is supplied from the air opening 109c into the housing 10 for a predetermined time (for example, 1 minute). As described above, the dry processing can be executed after a multi-stage cleaning operation is executed.

In step SJ14, it is determined whether or not the error related to ink contamination occurs, and in a case where the error related to ink contamination does not occur, the processing proceeds to step SJ15, and the start-up processing execution unit 101f executes normal start-up processing. In step SJ16, the start-up processing is completed.

In a case where the error related to ink contamination occurs, the processing proceeds to step SJ17 to determine whether or not the in-line cleaning operation is retried a predetermined number of times. When the in-line cleaning operation is not retried the predetermined number of times, the processing proceeds to step SJ10. When the in-line cleaning operation is retried the predetermined number of times, the processing proceeds to step SJ18, the self-recovery operation is stopped, and the cleaning operation by the cleaning and placing unit 200 or the handling by the user is urged. In the preventive cleaning, the solvent turned into mist may be used as described above, or the solvent ejected from the cleaning nozzle 17 may be used. Furthermore, the preventive cleaning may be executed by immersion cleaning.

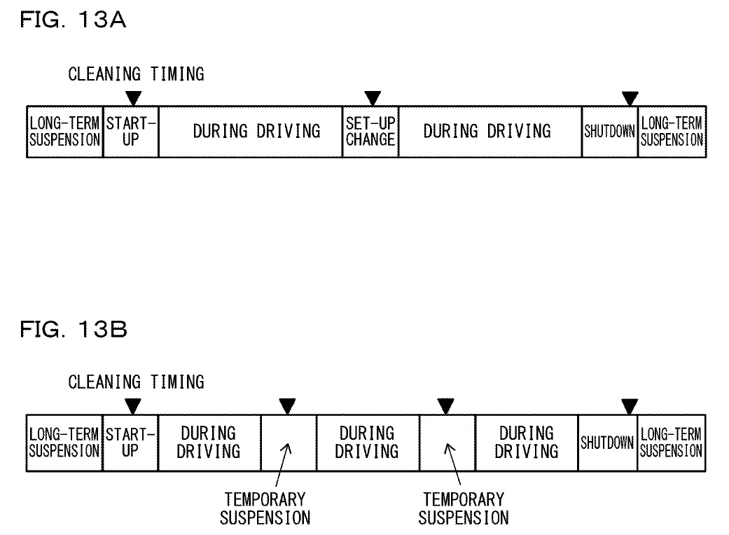

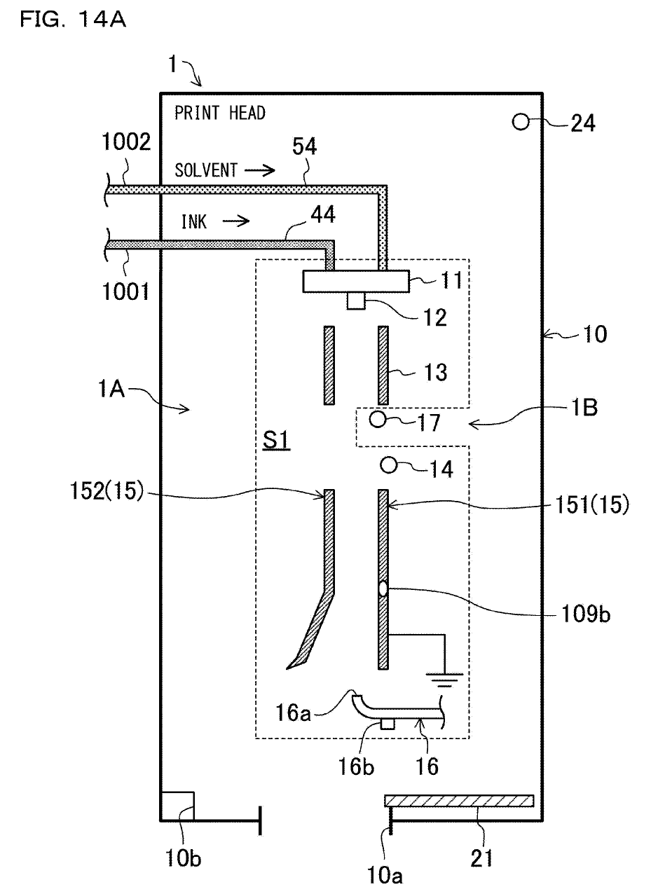

FIG. 13A is a time chart illustrating a timing of preventive cleaning according to a first example. After long-term suspension of the inkjet recording device I, when the start-up processing execution unit 101f executes the start-up processing, the cleaning control unit 101a executes the preventive cleaning processing. That is, the preventive cleaning processing is executed when the state of the inkjet recording device I transitions from the long-term suspension to the started state.

Thereafter, in a case where driving of the inkjet recording device I ends and set-up change occurs, the cleaning control unit 101a executes preventive cleaning processing such as, for example, mist cleaning at the time of the set-up change. That is, the preventive cleaning processing is executed when the state of the inkjet recording device I transitions from the driving state to the set-up change state. Printing is not executed even though a printing trigger is input during the preventive cleaning processing. Thereafter, the driving of the inkjet recording device I ends, and the preventive cleaning processing is also executed when shutdown processing is executed. That is, the preventive cleaning processing is executed when the state of the inkjet recording device I transitions from the driving state to the long-term suspension state. Since printing has been performed so far in the shutdown processing, it can be estimated that the ink deposits do not occur. At the end of the shutdown processing, the cleaning control unit 101a automatically performs mist cleaning by switching a liquid ejected from the print nozzle 12 from the ink to the solvent. After the preventive cleaning processing is executed, the long-term suspension is started.

FIG. 13B is a time chart illustrating a timing of preventive cleaning according to a second example. After the long-term suspension of the inkjet recording device I, the start-up processing execution unit 101f executes the preventive cleaning processing when the start-up processing is executed. Thereafter, the cleaning control unit 101a executes the preventive cleaning processing such as mist cleaning, for example, at a timing when the driving of the inkjet recording device I is temporarily suspended. That is, the preventive cleaning processing is executed when the state of the inkjet recording device I transitions from the driving state to the temporary suspension state. Printing is not executed even though the printing trigger is input during the preventive cleaning processing. When there is a plurality of temporary suspensions, the preventive cleaning processing may be executed every temporary suspension, or the preventive cleaning processing may be executed at a frequency of once every two temporary suspensions, for example. Furthermore, the preventive cleaning processing may not be executed on the temporary suspension.

Thereafter, the driving of the inkjet recording device I ends, and the preventive cleaning processing is also executed when the shutdown processing is executed. After the preventive cleaning processing is executed, the long-term suspension is started. As described above, when the state of the inkjet recording device I transitions, the cleaning control unit 101a executes the cleaning processing of automatically cleaning the components of the print head 1 by using the cleaning nozzle 17, the air jetting unit 109b, and the like.

Note that, as described above, "when the state of the inkjet recording device I transitions" can be at least one or more state transition timings of "when the state of the inkjet recording device I transitions from the long-term suspension to the started state", "when the state of the inkjet recording device I transitions from the driving state to the set-up change state", "when the state of the inkjet recording device I transitions from the driving state to the long-term suspension state", and "when the state of the inkjet recording device I transitions from the driving state to the temporary suspension state". A timing at which the cleaning processing is executed is stored in the storage unit 102, as the information related to head cleaning. The cleaning control unit 101a automatically executes the cleaning processing based on the information related to head cleaning stored in the storage unit 102.

Furthermore, the timing at which the cleaning processing is executed may be configured to be settable by the user via the operation display unit 103. For example, a plurality of selection items (for example, check boxes) associated with a state transition timing may be displayed on the display unit 103a, and the user may be configured to be able to select each item via the operation unit 103b. The content selected by the user is stored in the storage unit 102, as the information related to head cleaning. Further, a selection item for enabling or disabling automatic cleaning may be provided. For example, in a case where "when the state of the inkjet recording device I transitions from the long-term suspension to the started state" and "when the state of the inkjet recording device I transitions from the driving state to the set-up change state" are selected as the cleaning timing, a selection item for temporarily disabling only the latter may be provided. In this case, the components of the print head 1 are automatically cleaned only when the state of the inkjet recording device I transitions from the long-term suspension to the started state. Information regarding selection items for enabling or disabling the automatic cleaning is also stored in the storage unit 102.

### Modifications

In the above embodiment, the head module 1B includes the pressurizer 11, the print nozzle 12, the charging electrode 13, the deflection electrode 15, the gutter 16, and the cleaning nozzle 17, but the invention is not limited thereto.

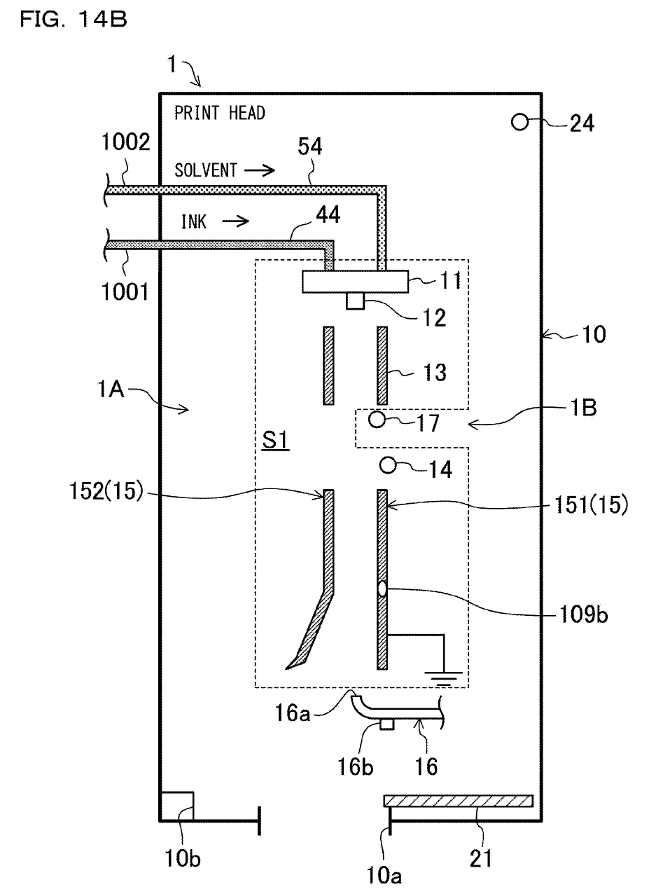

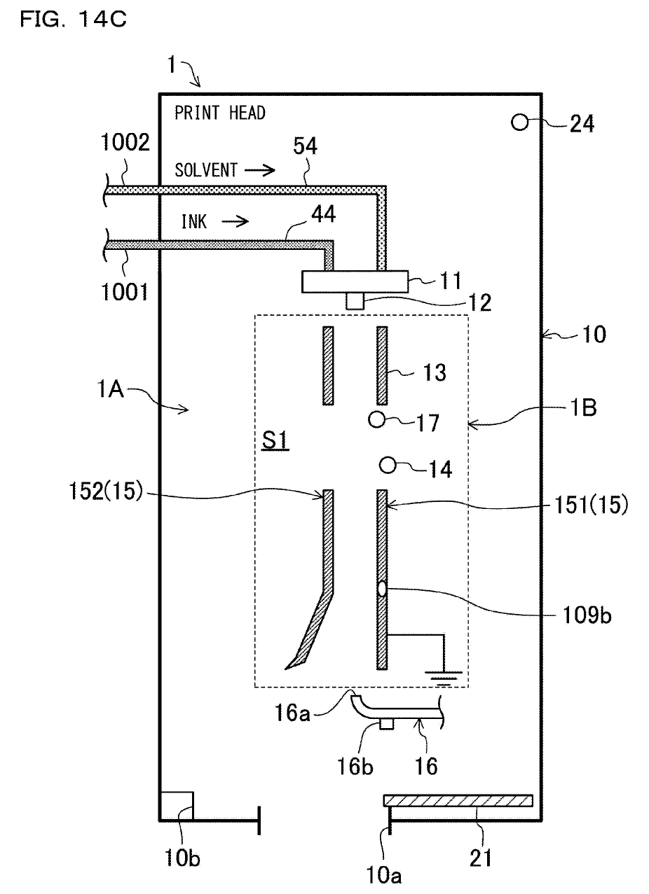

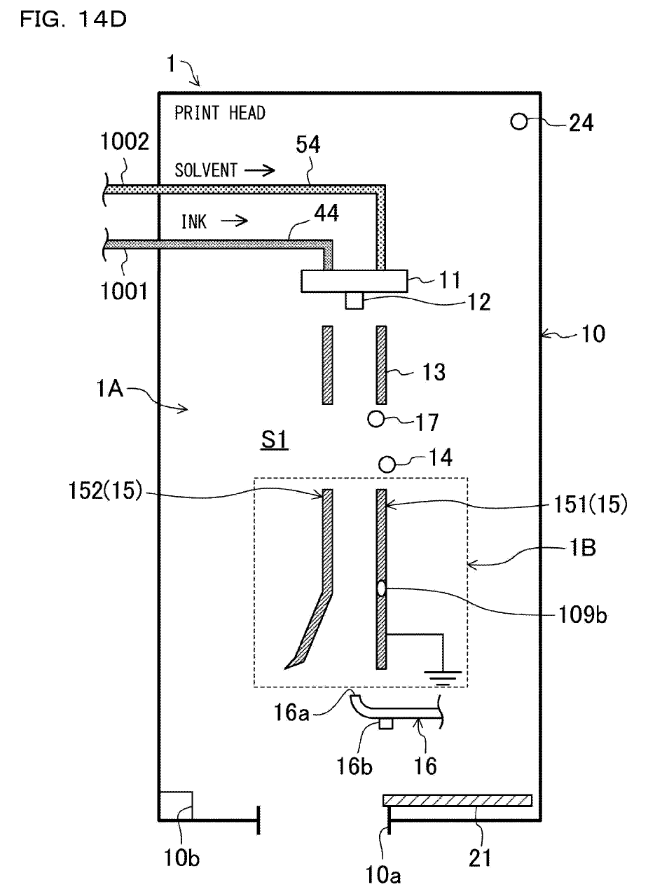

FIG. 14A is a diagram according to Modification 1, and in this Modification 1, the head module 1B (a portion surrounded by a broken line) does not include the cleaning nozzle 17. Furthermore, FIG. 14B is a diagram according to Modification 2, and in Modification 2, the head module 1B does not include the gutter 16 and the cleaning nozzle 17. Furthermore, FIG. 14C is a diagram according to Modification 3. In Modification 3, the head module 1B does not include the pressurizer 11, the print nozzle 12, and the gutter 16. Furthermore, FIG. 14D is a diagram according to Modification 4. In this Modification 4, the head module 1B does not include the pressurizer 11, the print nozzle 12, the charging electrode 13, the gutter 16, and the cleaning nozzle 17. As described above, the components included in the head module 1B can be voluntarily set.

The above embodiment is merely an example in all respects, and should not be construed in a limiting manner. Further, all modifications and changes falling within the equivalent scope of the claims are within the scope of the invention.

As described above, the inkjet recording device according to the disclosure can be used, for example, in a case where printing is performed on various workpieces or the like.

What is claimed is:

1. A continuous inkjet recording device comprising:
a print head that houses a print nozzle that ejects particulate ink, a charging electrode that charges the particulate ink ejected from the print nozzle, a deflection electrode that deflects a flying direction of the ink charged by the charging electrode, and a gutter that collects ink not deflected by the deflection electrode therein, and ejects the ink deflected by the deflection electrode to an outside;
a controller that includes an ink supply unit that supplies the ink to the print head, a solvent supply unit that supplies a solvent to the print head, and a control unit that controls the ink supply or the solvent supply from the ink supply unit or the solvent supply unit to the print head; and
a cable that fluidly and electrically connects the print head and the controller, and supplies the ink from the controller to the print head,
wherein the print head includes
a head body to which the cable is connected and which supplies the ink to the print nozzle via the cable, and
a separation head module that is configured to be detachable from the head body, and houses at least an electrode related to the deflection of the ink, and
the inkjet recording device further includes a cleaning unit that cleans the electrode related to the deflection of the ink housed in the separation head module.

2. The inkjet recording device according to claim 1,
wherein the cleaning unit includes a first solvent ejection nozzle that ejects the solvent supplied from the controller via the head body.

3. The inkjet recording device according to claim 2,
wherein the first solvent ejection nozzle ejects the solvent to at least one of the print nozzle, the charging electrode, and the deflection electrode.

4. The inkjet recording device according to claim 3,
wherein the control unit of the controller causes the first solvent ejection nozzle to eject an amount of the solvent that does not leak from the print head.

5. The inkjet recording device according to claim 2,
wherein the first solvent ejection nozzle is provided in the head body, and ejects the solvent toward the separation head module.

6. The inkjet recording device according to claim 2,
wherein the first solvent ejection nozzle is provided in the separation head module, and ejects the solvent toward the head body.

7. The inkjet recording device according to claim 1,
wherein the cleaning unit includes an air nozzle that jets air toward the solvent ejected from the print nozzle, and
the control unit of the controller causes the air nozzle to jet the air in a state where the solvent is ejected from the print nozzle.

8. The inkjet recording device according to claim 7,
wherein the control unit of the controller manages a use amount of the solvent such that the solvent does not leak from the print head by controlling an amount of the solvent flowing per unit time on a jetting axis line of the air nozzle.

9. The inkjet recording device according to claim 1,
wherein the cleaning unit includes a second solvent ejection nozzle on which the print head is placed, and which ejects the solvent toward the print head.

10. The inkjet recording device according to claim 9,
wherein the second solvent ejection nozzle ejects the solvent toward the electrode related to the deflection of the ink in the separation head module.

11. The inkjet recording device according to claim 9,
wherein the second solvent ejection nozzle ejects the solvent supplied from the controller via the head body.

12. The inkjet recording device according to claim 9,
wherein the second solvent ejection nozzle further ejects the solvent toward at least a part of a contact part where the separation head module is in contact with the head body.

13. The inkjet recording device according to claim 9,
wherein the cleaning unit includes a reserving unit that reserves the solvent ejected from the second solvent ejection nozzle, and immerses a whole or a part of the placed print head in the solvent.

14. The inkjet recording device according to claim 9,
wherein the control unit of the controller executes dry processing of drying an inside of the print head after the electrode related to the deflection of the ink is automatically cleaned, and then executes start-up processing of achieving a printable state by collecting the ink continuously ejected from the print nozzle in the print head by the gutter.
